(19) United States
(12) Patent Application Publication
(10) Pub. No.: US 2026/0231305 A1
(43) Pub. Date: Aug. 6, 2026

(54) COOKING APPARATUS AND METHOD FOR CONTROLLING THE SAME

(71) Applicant: Samsung Electronics Co., Ltd., Suwon-si (KR)

(72) Inventors: Youngwook WOO, Suwon-si (KR); Sangwon YUN, Suwon-si (KR); Haeun KIM, Suwon-si (KR); Juhyun KIM, Suwon-si (KR); Sunhee KOO, Suwon-si (KR)

(21) Appl. No.: 19/442,498

(22) Filed: Jan. 7, 2026

Related U.S. Application Data
(63) Continuation of application No. PCT/KR2026/000231, filed on Jan. 6, 2026.

(30) Foreign Application Priority Data
Feb. 5, 2025 (KR) 10-2025-0014777

(51) Int. Cl. H05B 6/64; F24C 15/32

(52) U.S. Cl. CPC H05B 6/6485; F24C 15/325; H05B 6/642; H05B 6/645

(57) ABSTRACT

A cooking apparatus is provided. The cooking apparatus includes a main body comprising a cooking chamber, a first heat source disposed in the cooking chamber to generate radiant heat, a second heat source disposed in the cooking chamber to generate convection heat, a microwave radiator configured to generate microwaves inside the cooking chamber, an electrical component room partitioned from the cooking chamber and provided to receive the microwave radiator, a cooling fan configured to draw in outside air and discharge the outside air to the electrical component room so as to cool the electrical component room, a guide duct provided to guide air discharged from the cooling fan into the cooking chamber, and an opening and closing device configured to open and close the guide duct.

### CROSS-REFERENCE TO RELATED APPLICATION(S

This application is a continuation application, claiming priority under 35 U.S.C. § 365(c), of an International application No. PCT/KR2026/000231, filed on January 6, 2026, which is based on and claims the benefit of a Korean patent application number 10-2025-0014777, filed on February 5, 2025, in the Korean Intellectual Property Office, the disclosure of which is incorporated by reference herein in its entirety.

### TECHNICAL FIELD

The disclosure relates to a cooking apparatus. More particularly, the disclosure relates to a cooking apparatus and a method for controlling the same.

### BACKGROUND ART

A cooking apparatus is a device that heats and cooks an object to be cooked, such as food, and refers to an appliance that provides various cooking-related functions such as heating, thawing, drying, and sterilizing the object to be cooked. Examples of such cooking apparatus may include an oven, such as a gas oven or electric oven, a microwave heating device (hereinafter referred to as a microwave), a gas range, an electric range, a gas grill, or an electric grill.

In general, an oven is a device that cooks food by directly transferring heat to the food or heating an inside of a cooking chamber through a heat source that generates heat, such as a heater. A microwave is a device that cooks food by using frictional heat between molecules that is generated by disrupting a molecular arrangement of the food with a high frequency as a heat source.

Additionally, a cooking apparatus that is equipped with two or more different types of heat sources to cook different types of food simultaneously has recently been released.

The above information is presented as background information only to assist with an understanding of the disclosure. No determination has been made, and no assertion is made, as to whether any of the above might be applicable as prior art with regard to the disclosure.

### DISCLOSURE

### Technical Problem

Aspects of the disclosure are to address at least the above-mentioned problems and/or disadvantages and to provide at least the advantages described below. Accordingly, an aspect of the disclosure is to provide a cooking apparatus having improved cooking performance.

Another aspect of the disclosure is to provide a cooking apparatus capable of reducing a cooking speed.

Additional aspects will be set forth in part in the description which follows and, in part, will be apparent from the description, or may be learned by practice of the presented embodiments.

### Technical Solution

In accordance with an aspect of the disclosure, a cooking apparatus is provided. The cooking apparatus includes a main body including a cooking chamber, a first heat source disposed in the cooking chamber to generate radiant heat, a second heat source disposed in the cooking chamber to generate convection heat, a microwave radiator configured to generate microwaves inside the cooking chamber, an electrical component room partitioned from the cooking chamber and provided to receive the microwave radiator, a cooling fan configured to draw in outside air and discharge the outside air to the electrical component room so as to cool the electrical component room, a guide duct provided to guide air discharged from the cooling fan into the cooking chamber, and an opening and closing device configured to open and close the guide duct.

In accordance with another aspect of the disclosure, a method performed by a cooking apparatus that includes a main body including a cooking chamber, a first heat source disposed in the cooking chamber to generate radiant heat, a second heat source disposed in the cooking chamber to generate convection heat, a microwave radiator configured to generate microwaves inside the cooking chamber, an electrical component room partitioned from the cooking chamber and provided to receive the microwave radiator, a cooling fan configured to draw in outside air and discharge the outside air to the electrical component room so as to cool the electrical component room, and a guide duct provided to guide air discharged from the cooling fan into the cooking chamber is provided. The method includes, based on an air-frying mode, among a plurality of modes, being started, driving the first heat source, the second heat source, and the cooling fan, and closing the guide duct.

### Advantageous Effects

Cooking performance of a cooking apparatus may be improved.

Further, a cooking speed of a cooking apparatus may be reduced.

Further, in an air-frying mode of a cooking apparatus, heat loss caused by cold air flowing into a cooking chamber may be minimized.

Further, in an air-frying mode of a cooking apparatus, a temperature of a surface of a main body and a temperature of an internal component may be prevented from increasing.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a perspective view of a cooking apparatus according to an embodiment of the disclosure;

FIG. 2 is an exploded view illustrating some components of the cooking apparatus illustrated in FIG. 1 according to an embodiment of the disclosure;

FIG. 3 is a cross-sectional view of the cooking apparatus illustrated in FIG. 1 according to an embodiment of the disclosure;

FIG. 4 is an exploded view of the cooking apparatus illustrated in FIG. 1 according to an embodiment of the disclosure;

FIG. 5 is a view illustrating an opening and closing device of the cooking apparatus according to an embodiment of the disclosure;

FIG. 6 is an exploded perspective view illustrating the opening and closing device installed in a guide duct of the cooking apparatus according to an embodiment of the disclosure;

FIG. 7 is a view illustrating an air flow state according to inflow of outside air when the guide duct is opened by the opening and closing device according to an embodiment of the disclosure;

FIG. 8 is a view illustrating an operating state of the opening and closing device illustrated in FIG. 7 according to an embodiment of the disclosure;

FIG. 9 is a view illustrating the air flow due to operation of the opening and closing device illustrated in FIG. 8 according to an embodiment of the disclosure;

FIG. 10 is a view illustrating the air flow state according to the inflow of the outside air when the guide duct is closed by the opening and closing device according to an embodiment of the disclosure;

FIG. 11 is a view illustrating the operating state of the opening and closing device illustrated in FIG. 10 according to an embodiment of the disclosure;

FIG. 12 is a view illustrating the air flow due to the operation of the opening and closing device illustrated in FIG. 10 according to an embodiment of the disclosure;

FIG. 13 illustrates a control block diagram of the cooking apparatus according to an embodiment of the disclosure;

FIG. 14 is a flowchart illustrating whether the guide duct is opened or not according to a driving mode of the cooking apparatus according to an embodiment of the disclosure; and

FIG. 15 is a flowchart illustrating operation of components of the cooking apparatus when the cooking apparatus operates in an air-frying mode according to an embodiment of the disclosure.

Throughout the drawings, it should be noted that like reference numbers are used to depict the same or similar elements, features, and structures.

### MODES OF THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the drawings, similar reference numerals may be used to designate similar constituent elements.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of "and / or" includes a plurality of combinations of relevant items or any one item among a plurality of relevant items.

Herein, the expressions “a first”, “a second”, “the first”, “the second”, etc., may simply be used to distinguish an element from other elements, but is not limited to another aspect (importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

In this disclosure, the terms "including", "having", and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

In the following detailed description, the terms of "front side", "rear side", “left side”, "right side" and the like may be defined by the drawings, but the shape and the location of the element is not limited by the term.

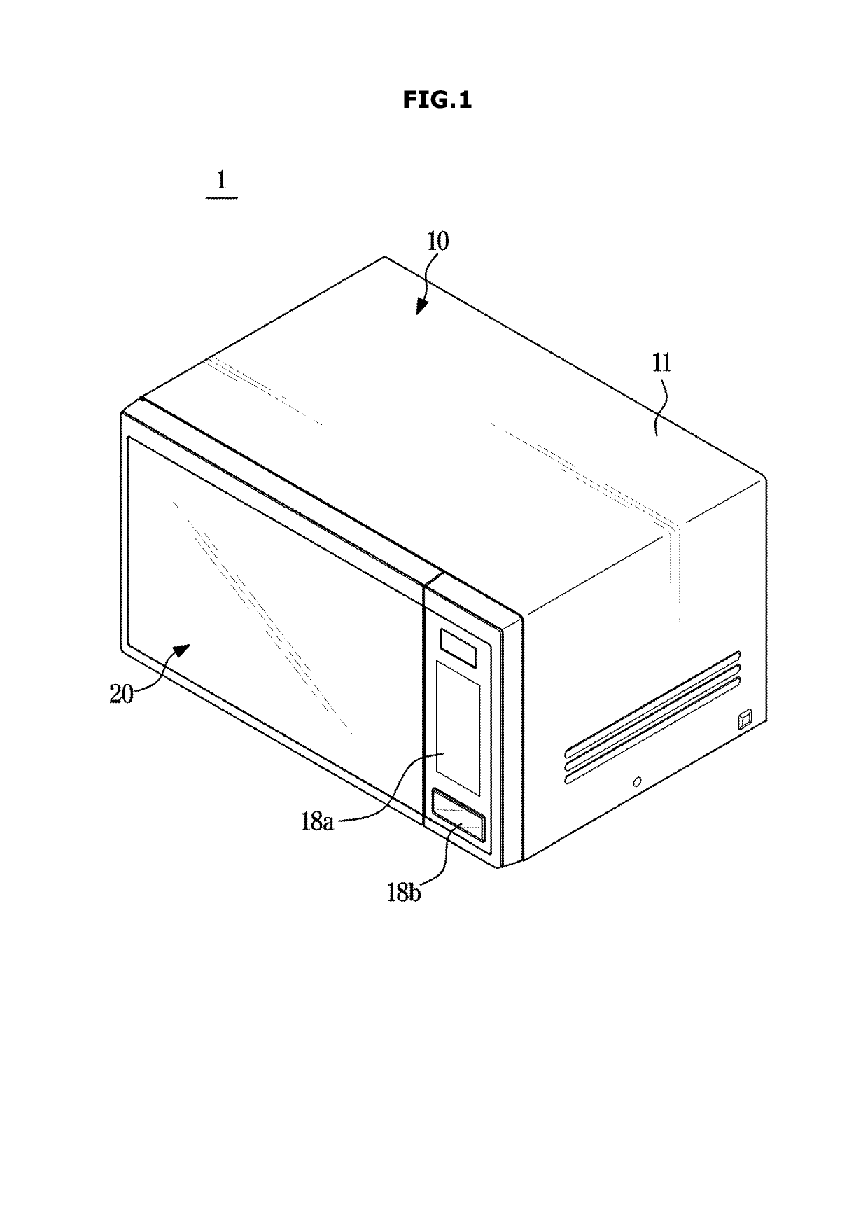

For example, referring to FIG. 1, a X direction may be referred to as a front and rear direction, a Y direction may be referred to as a left and right direction, and a Z direction may be referred to as an up and down direction. For example, referring to FIG. 1, a direction to which a door 20 of a cooking apparatus 1 faces may be defined as the front side (+X direction), and an opposite direction may be defined as the rear side (-X direction).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Hereinafter, various embodiments of the disclosure will be described in detail with reference to the accompanying drawings.

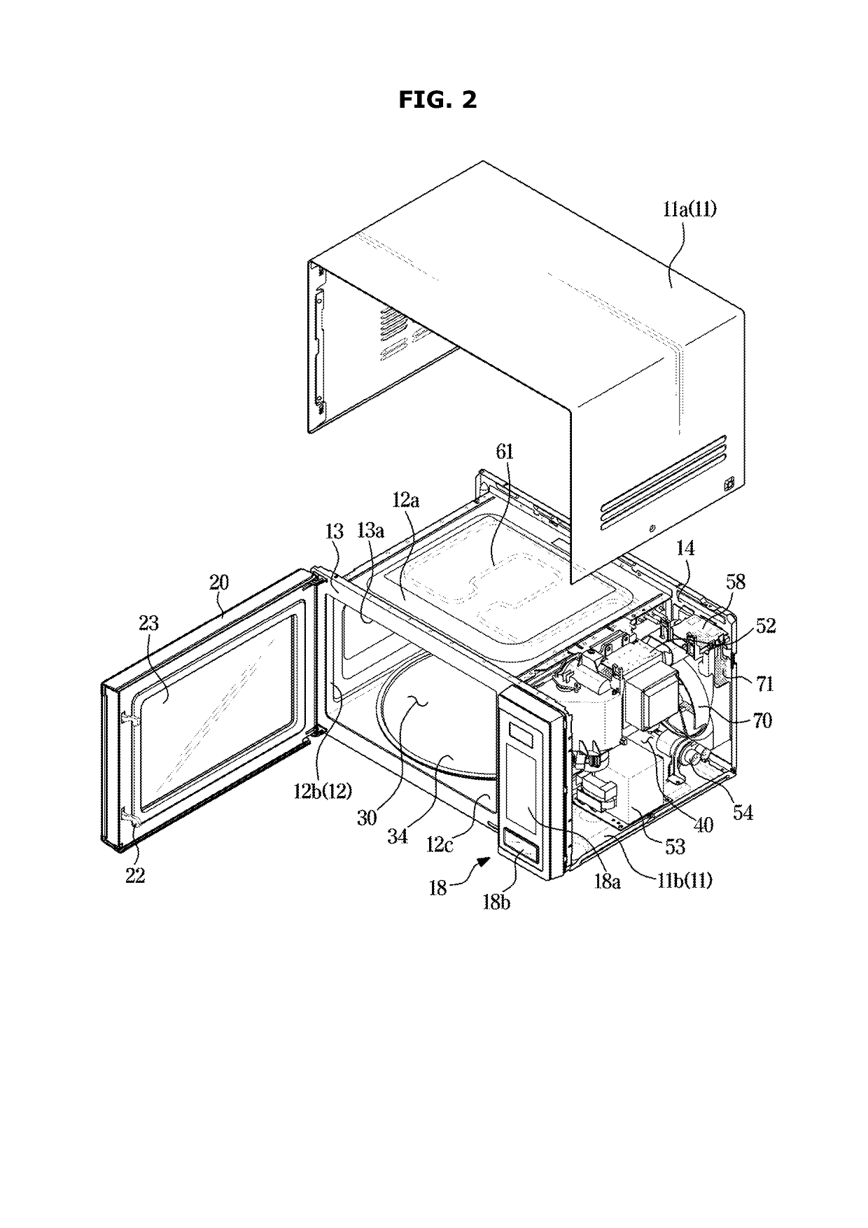

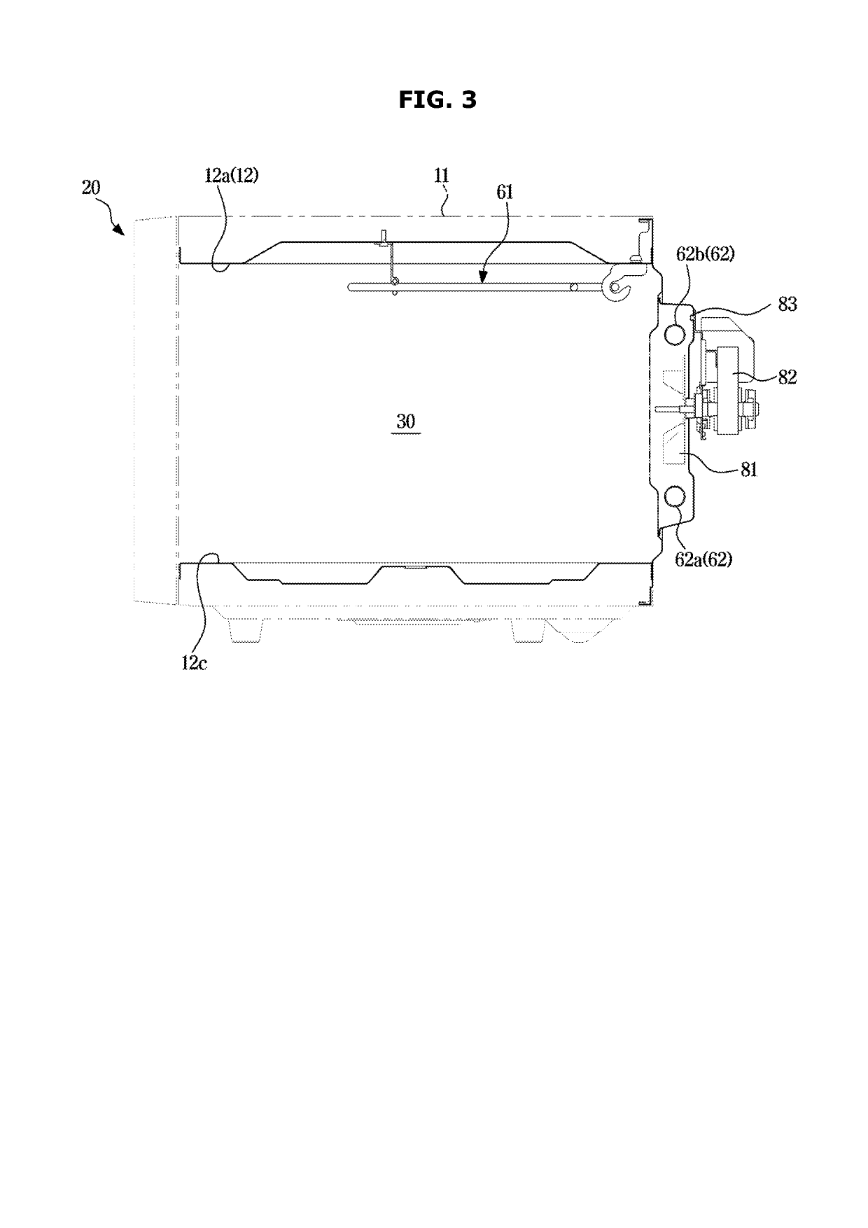

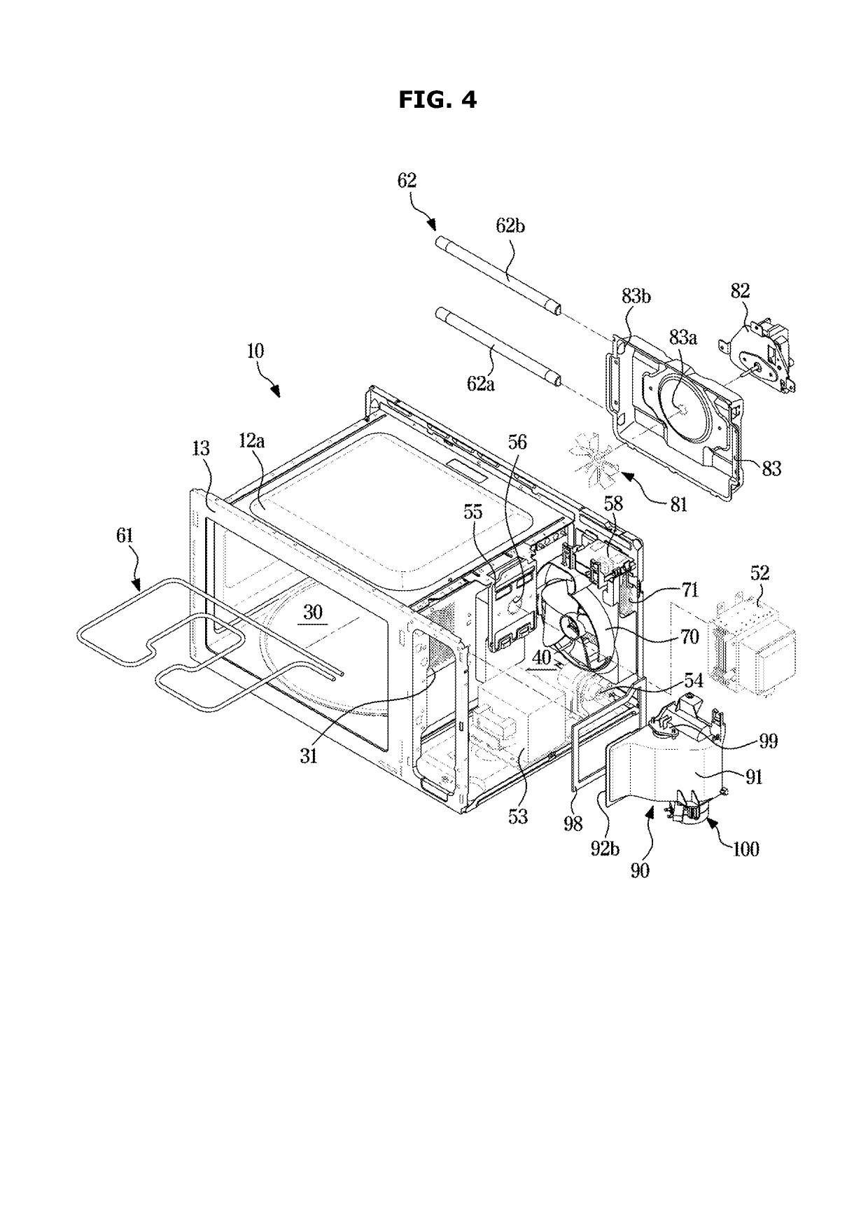

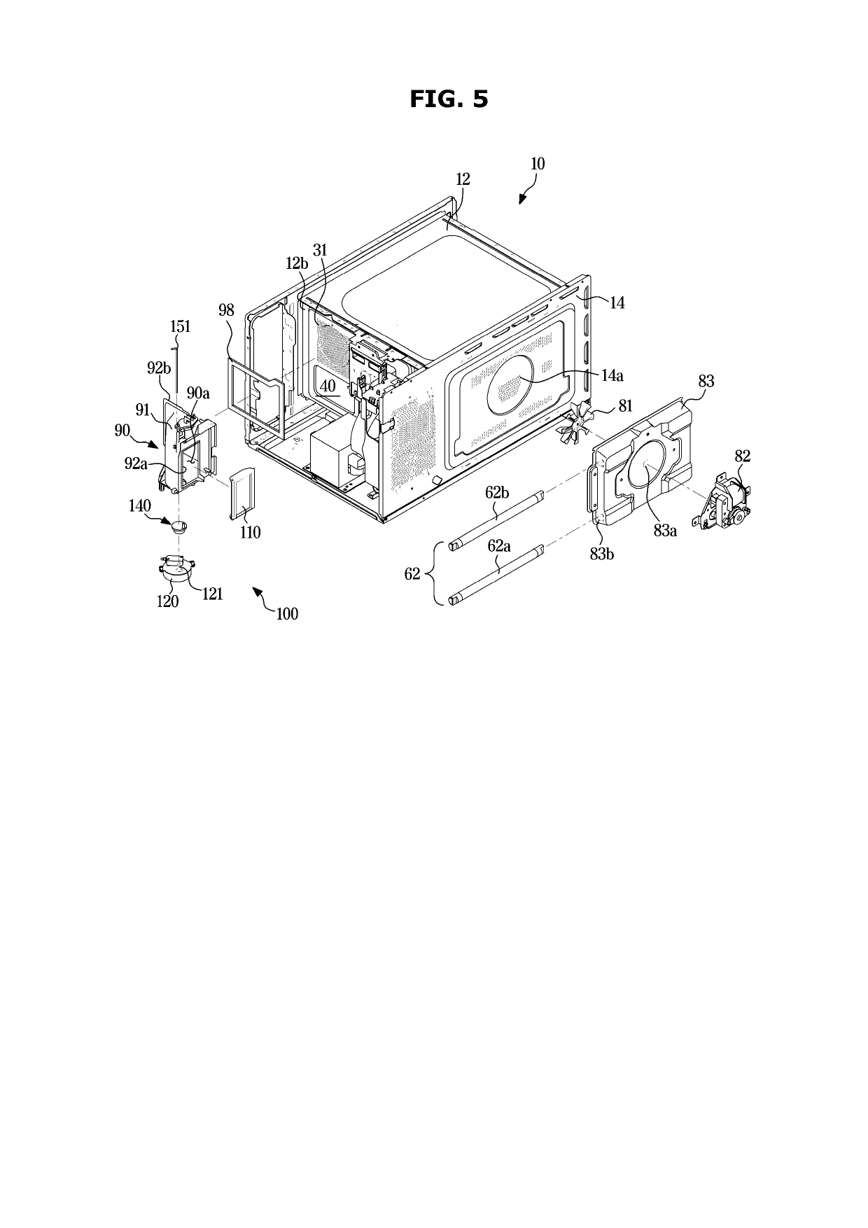

FIG. 1 is a perspective view of a cooking apparatus according to an embodiment of the disclosure. FIG. 2 is an exploded view illustrating some components of the cooking apparatus illustrated in FIG. 1 according to an embodiment of the disclosure. FIG. 3 is a cross-sectional view of the cooking apparatus illustrated in FIG. 1 according to an embodiment of the disclosure. FIG. 4 is an exploded view of the cooking apparatus illustrated in FIG. 1 according to an embodiment of the disclosure. FIG. 5 is a view illustrating an opening and closing device of the cooking apparatus according to an embodiment of the disclosure.

Referring to FIGS. 1 to 5, the cooking apparatus 1 may include a main body 10 and a door 20 coupled to a front side of the main body 10.

A cooking chamber 30 and an electrical component room 40 may be disposed inside the main body 10.

The main body 10 may include an outer cabinet 11 and an inner cabinet 12. The inner cabinet 12 may be disposed on an inside of the outer cabinet 11.

The outer cabinet 11 may be provided to cover at least a portion of the inner cabinet 12. For example, the outer cabinet 11 may include a cover frame 11a and a bottom plate 11b. The cover frame 11a and the bottom plate 11b may be provided as separate components and then coupled to each other. Alternatively, the cover frame 11a and the bottom plate 11b may be formed integrally with each other.

The inner cabinet 12 may include an upper plate 12a, a side plate 12b, and a lower plate 12c. For example, the upper plate 12a, the side plate 12b, and the lower plate 12c may be provided as separate components and then coupled to each other. Alternatively, the upper plate 12a, the side plate 12b, and the lower plate 12c may be formed integrally with each other.

The side plate 12b may be referred to as a side wall. The side plate 12b may be referred to as a left wall and/or a right wall.

For example, the main body 10 may include a front plate 13 disposed at the front of the inner cabinet 12. The main body 10 may include a rear plate 14 disposed at the rear of the inner cabinet 12.

The front plate 13 may include an opening 13a. The opening 13a may be provided to allow a front side of the cooking chamber 30 to open. A user can access the cooking chamber 30 through the opening 13a.

An air intake port 71 may be formed on the rear plate 14. The air intake port 71 may be formed in at least a portion of the rear plate 14. The air intake port 71 may be formed in at least a portion of the rear plate 14 corresponding to the electrical component room 40. Air may be introduced into the main body 10 through the air intake port 71. The air introduced into the main body 10 through the air intake port 71 may cool the electrical component room 40.

The electrical component room 40 may be provided to receive electrical components for operating the cooking apparatus 1. For example, the electrical component room 40 may be disposed on one side of the cooking chamber 30. However, the disclosure is not limited thereto, and the electrical component room 40 may also be disposed on an upper side of the cooking chamber 30.

The door 20 may be configured to open and close the cooking chamber 30. The door 20 may be rotatably coupled to the main body 10.

The door 20 may include a door protrusion 22 provided to be coupled to the main body 10. The door protrusion 22 may be formed at a rear side of the door 20. The door protrusion 22 may protrude toward the main body 10.

The door protrusion 22 may be provided to be coupled to a catch (not shown) of the front plate 13. The door protrusion 22 may pass through the catch (not shown) of the front plate 13 and be fixed to a latch assembly (not shown) disposed inside the main body 10.

The door 20 may further include a choke (not shown) to shield or reduce electromagnetic wave leakage. The door 20 may further include a viewing window 23 to allow a cooking process to be visually observed.

A front cover portion 18 may be disposed on a lateral side of the main body 10. For example, the front cover portion 18 may be positioned on one side of the front plate 13 and provided to cover a front side of the electrical component room 40.

A manipulating portion 18a may be disposed in the front cover portion 18. The manipulating portion 18a may be configured to receive user input. The manipulating portion 18a may be provided to display an operating state of the cooking apparatus 1. For example, the manipulating portion 18a may include at least one of a touch panel and a display panel. For example, although not shown in the drawing, the manipulating portion 18a may include at least one of a button or a knob.

The cooking apparatus 1 may further include a button 18b mounted on the front cover portion 18. The cooking apparatus 1 may be configured to open the door 20 by operating the button 18b when the door 20 is in a position to close the cooking chamber 30.

The cooking chamber 30 may be provided as a space in which food is cooked. The cooking chamber 30 may be formed by the inner cabinet 12. For example, the cooking chamber 30 may be formed by the inner cabinet 12, the front plate 13, and the rear plate 14.

The cooking apparatus 1 may include a tray 34 disposed inside the cooking chamber 30 to receive an object to be cooked. The tray 34 may be configured to be rotatable inside the cooking chamber 30 to allow food placed on the tray 34 to be heated evenly.

The cooking chamber 30 may be configured to cook food by at least one heat source. For example, the heat source may include a microwave radiator 52 configured to supply microwaves (electromagnetic waves) to food. For example, the microwave radiator 52 may be a magnetron. The microwave radiator 52 may be referred to as an electromagnetic wave generating device. For example, the microwave radiator 52 may be coupled to a side wall of the cooking chamber 30. For example, the microwave radiator 52 may communicate with the side plate 12b forming the cooking chamber 30.

Microwaves generated from the microwave radiator 52 may be guided into the cooking chamber 30 through a wave guide 55. For example, the wave guide 55 may be coupled to a side wall of the cooking chamber 30. For example, the wave guide 55 may communicate with the side plate 12b forming the cooking chamber 30. For example, one side of the wave guide 55 may be connected to the microwave radiator 52, and the other side of the wave guide 55 may be connected to the cooking chamber 30. For example, the other side of the wave guide 55 may communicate with the side plate 12b forming the cooking chamber 30.

A microwave inlet 56, to which microwaves guided from the wave guide 55 are introduced, may be formed in the cooking chamber 30. For example, the microwave inlet 56 may be formed on the right wall of the cooking chamber 30. Electromagnetic waves introduced into the cooking chamber 30 through the microwave inlet 56 may cook food while resonating within the cooking chamber 30.

A high voltage transformer (HVT) 53, a high voltage condenser 54, and a circuit board 58 which are for driving the microwave radiator 52 may be disposed in the electrical component room 40.

The cooking apparatus 1 may include a cooling fan 70 configured to introduce air to cool the cooking chamber 30 and/or the electrical component room 40. The cooling fan 70 may be disposed in the main body 10. For example, the cooling fan 70 may be configured to cool the cooking chamber 30. For example, the cooling fan 70 may be configured to cool an internal configuration of the electrical component room 40.

The cooling fan 70 may be disposed inside the main body 10. The cooling fan 70 may be located in the electrical component room 40. The cooling fan 70 may be disposed on the rear plate 14 forming the electrical component room 40. The cooling fan 70 may be disposed in the air intake port 71 formed to introduce outside air into the electrical component room 40. The cooling fan 70 may be located in the air intake port 71 formed in the rear plate 14 to introduce outside air into the electrical component room 40. The cooling fan 70 may reduce temperatures of electrical components received in the electrical component room 40. By reducing the temperature of electrical components in the electrical component room 40 through the cooling fan 70, malfunctions and failures of the electrical components may be prevented.

The cooking apparatus 1 may include a guide duct 90 provided to guide outside air, which is introduced into the electrical component room 40 through the cooling fan 70, into the cooking chamber 30. The guide duct 90 may be disposed in the electrical component room 40. The guide duct 90 may be provided to cool the cooking chamber 30. For example, the guide duct 90 may be provided to guide outside air, which is introduced through the cooling fan 70, into the cooking chamber 30 so as to cool the cooking chamber 30.

Outside air introduced through the cooling fan 70 may be guided into the cooking chamber 30 through the guide duct 90. For example, the guide duct 90 may be coupled to a side wall of the cooking chamber 30. For example, the guide duct 90 may communicate with the side plate 12b forming the cooking chamber 30. For example, one side of the guide duct 90 may be connected to a communication hole 31 formed in the side plate 12b of the cooking chamber 30. For example, a sealing member 98 may be disposed between the guide duct 90 and the cooking chamber 30. For example, the sealing member 98 may be provided to allow air guided through the guide duct 90 to be introduced into the cooking chamber 30 through the communication hole 31.

The cooking apparatus 1 may be provided with a plurality of communication holes 31. The communication hole 31 may be disposed inside the cooking chamber 30 for introducing air guided from the guide duct 90. For example, the communication hole 31 may be formed on the right wall of the cooking chamber 30. For example, the communication hole 31 may be disposed on the side plate 12b of the cooking chamber 30. For example, the plurality of communication holes 31 may be disposed on the side plate 12b.

The cooking apparatus 1 may include an opening and closing device 100 for controlling inflow of air for cooling the cooking chamber 30 and/or the electrical component room 40. The opening and closing device 100 may be disposed in the guide duct 90. The opening and closing device 100 may be disposed inside the guide duct 90. The opening and closing device 100 may be configured to control the inflow of air into the guide duct 90. The opening and closing device 100 will be described in detail below.

A heat source of the cooking apparatus 1 may include a first heat source 61 configured to supply radiant heat to food. The first heat source 61 may be configured to supply vertical radiant heat to the food. The first heat source 61 may be disposed at an upper portion inside the cooking chamber 30. For example, the first heat source 61 may be disposed at the upper plate 12a. For example, the first heat source 61 may include a sheath heater. For example, the first heat source 61 may include a grill. For example, the first heat source 61 may include a grill heating portion configured to supply radiant heat to food at an upper portion inside the cooking chamber 30. For example, the cooking apparatus 1 may perform not only a microwave function but also an oven function by the first heat source 61.

The heat source of the cooking apparatus 1 may include a second heat source 62 configured to supply hot air to food. The second heat source 62 may be configured to supply hot air to the food. The second heat source 62 may be disposed on an outer rear surface of the cooking chamber 30. For example, the second heat source 62 may be disposed on the rear plate 14. For example, the second heat source 62 may be disposed on the rear plate 14 corresponding to the cooking chamber 30. For example, the second heat source 62 may include a quartz heater. For example, the second heat sources 62 may be disposed on upper and lower portions of the outer rear surface of the cooking chamber 30, respectively.

For example, the second heat source 62 may include a lower second heat source 62a located at a lower portion of the outer outside of the cooking chamber 30. For example, the second heat source 62 may include an upper second heat source 62b located at an upper portion of the outer outside of the cooking chamber 30. For example, the lower second heat source 62a and the upper second heat source 62b may be arranged parallel to each other at upper and lower portions of the rear wall of the cooking chamber 30. For example, the second heat source 62 may include a convection heating portion. For example, the second heat source 62 may be configured to allow convection hot air to be generated inside the cooking chamber 30 through the lower second heat source 62a and the upper second heat source 62b located at the upper and lower portions of the rear wall of the cooking chamber, and a circulation fan 81 located at a center thereof.

In the cooking apparatus 1, the circulation fan 81 for circulating air to evenly heat food, and a circulation motor 82 for driving the circulation fan 81 may be disposed on the rear surface of the cooking chamber 30. The circulation fan 81 may be disposed on at the outer rear surface of the cooking chamber 30. For example, the circulation fan 81 may be disposed at the rear plate 14. For example, the circulation fan 81 may be provided at the rear plate 14 corresponding to the cooking chamber 30. A plurality of holes 14a for allowing air to flow may be formed at the rear plate 14 corresponding to the cooking chamber 30. The plurality of holes 14a may be formed at least a portion of the rear plate 14. For example, the plurality of holes 14a may be formed at least a portion of the rear plate 14 corresponding to the cooking chamber 30.

The circulation fan 81 may be installed in the cooking chamber 30 by a circulation fan bracket 83. The circulation fan bracket 83 may be provided to cover the circulation fan 81. A circulation fan installation portion 83a may be disposed in the circulation fan bracket 83. The circulation fan installation portion 83a may be provided to connect the circulation fan 81 and the circulation motor 82. The circulation fan installation portion 83a may be located at a center of the circulation fan bracket 83. The circulation motor 82 and the circulation fan 81 may be installed on the circulation fan bracket 83.

A second heat source installation portion 83b may be disposed in the circulation fan bracket 83 for installing the second heat source 62 located at the rear side of the cooking chamber 30. For example, the second heat source installation portion 83b may be provided at upper and lower portions of the circulation fan bracket 83, respectively. For example, the second heat source installation portion 83b may be disposed in the lower portion of the circulation fan bracket 83 for installing the lower second heat source 62a. For example, the second heat source installation portion 83b may be disposed in the upper portion of the circulation fan bracket 83 for installing the upper second heat source 62b. For example, the second heat source installation portion 83b may be formed by opening at least a portion of the circulation fan bracket 83 to allow the second heat source 62 to penetrate therethrough and to be installed thereon. In the embodiment, it is illustrated that the second heat source installation portion is formed at the upper and lower portions of the circulation fan bracket, respectively, but is not limited thereto.

As for the microwave function that radiates electromagnetic waves to the cooking chamber 30 to cook food, moisture in the food may be released, and moisture may accumulate inside the cooking chamber 30. At this time, the opening and closing device 100 may open the guide duct 90 to supply air into the cooking chamber 30, thereby removing moisture inside the cooking chamber 30.

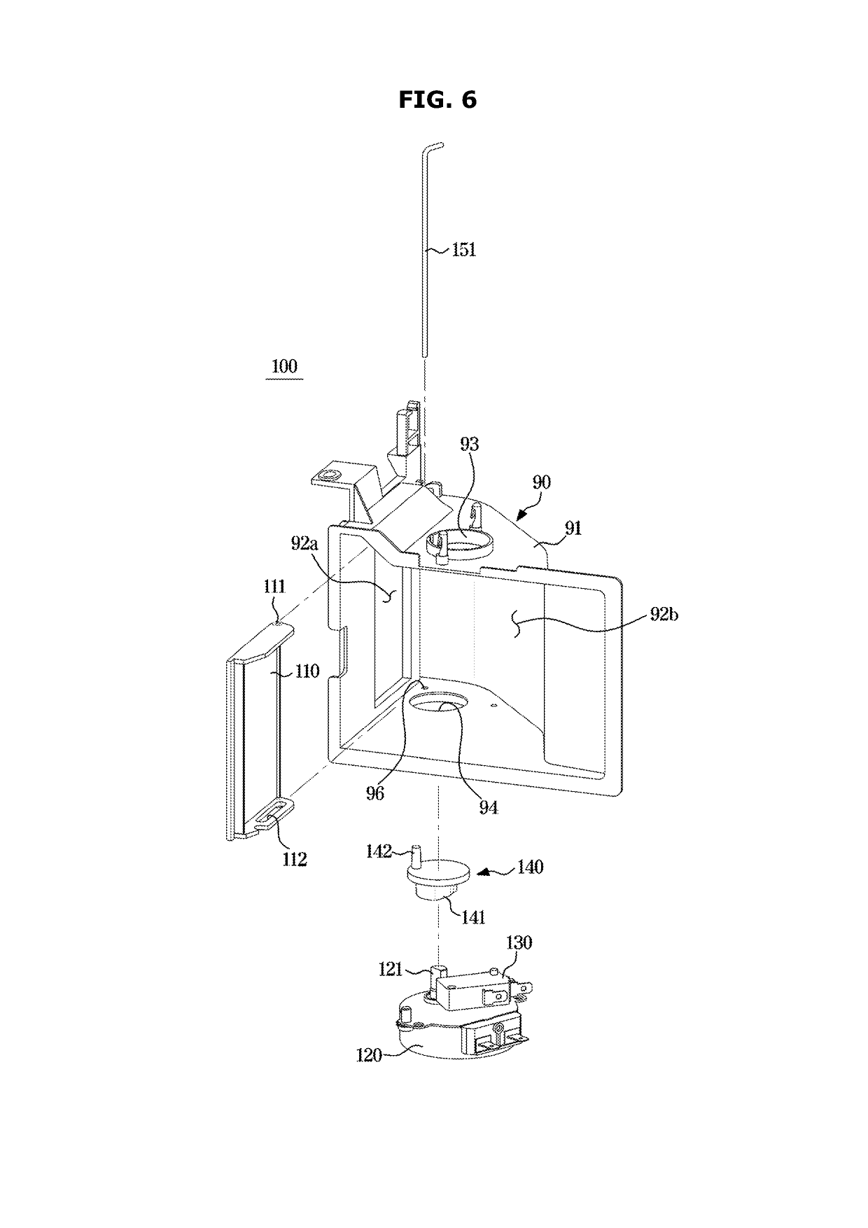

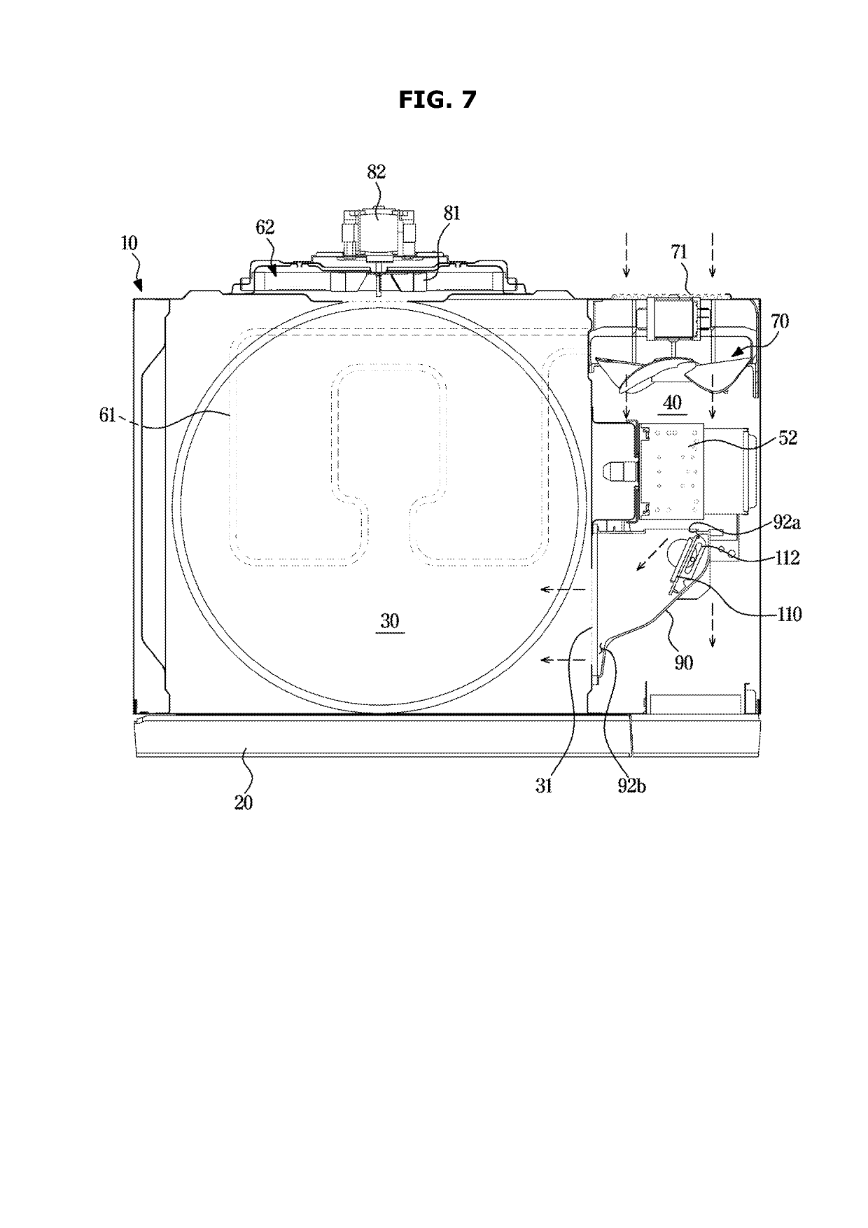

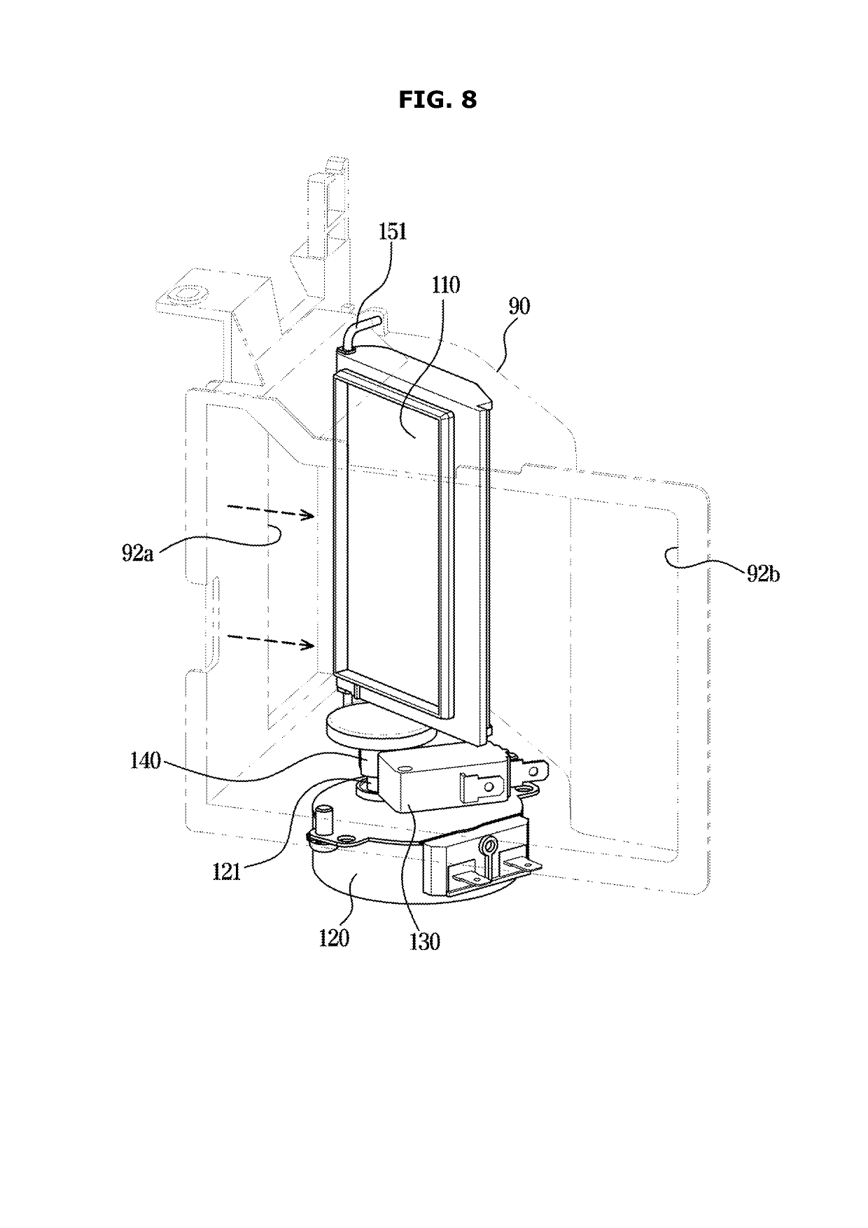

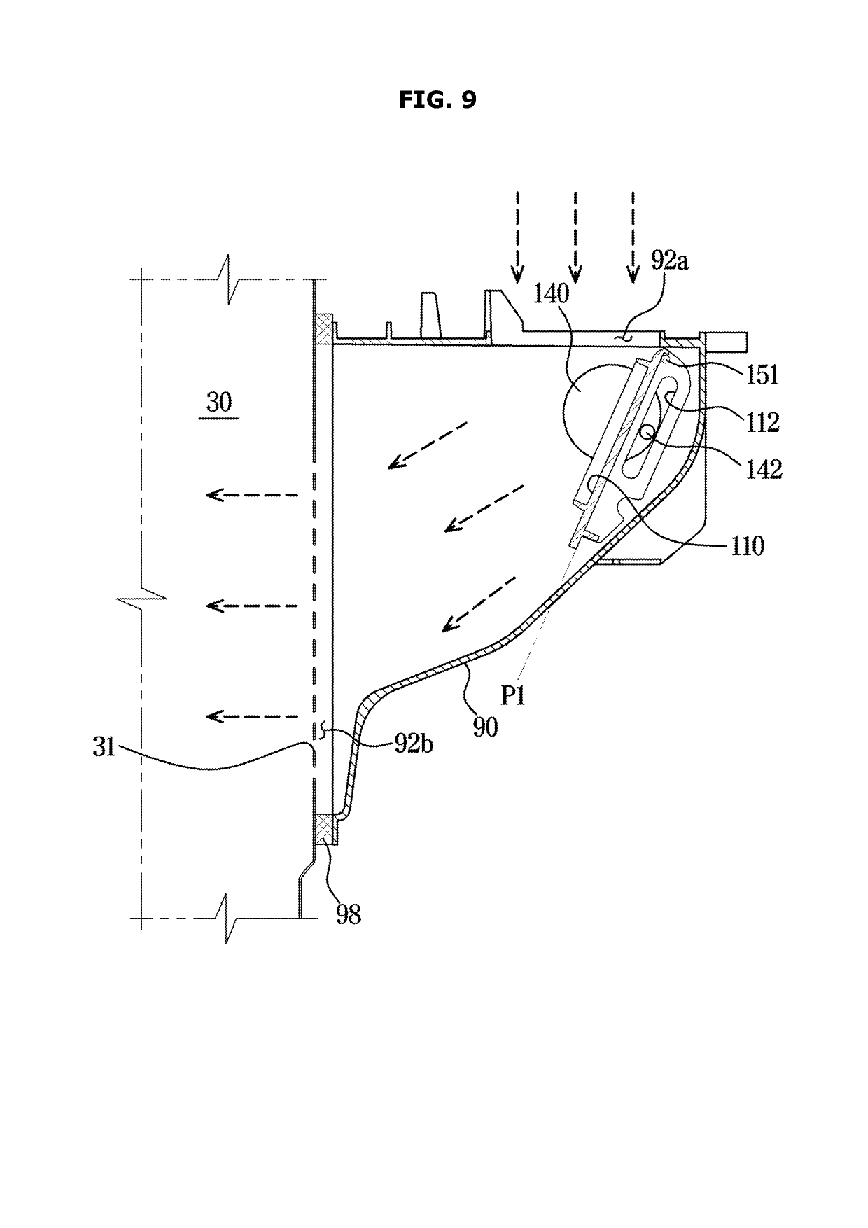

FIG. 6 is an exploded perspective view illustrating the opening and closing device installed in a guide duct of the cooking apparatus according to an embodiment of the disclosure. FIG. 7 is a view illustrating an air flow state according to inflow of outside air when the guide duct is opened by the opening and closing device according to an embodiment of the disclosure. FIG. 8 is a view illustrating an operating state of the opening and closing device illustrated in FIG. 7 according to an embodiment of the disclosure. FIG. 9 is a view illustrating the air flow due to the operation of the opening and closing device illustrated in FIG. 8 according to an embodiment of the disclosure.

Referring to FIGS. 6 to 9, the opening and closing device 100 may be disposed in the guide duct 90.

The guide duct 90 may be provided in the electrical component room 40 of the main body 10. The guide duct 90 may include a guide body 91 provided to allow air to move therein. The guide duct 90 may include a first opening 92a formed on one side thereof. The first opening 92a may be provided to allow air to flow into the guide duct 90. The opening and closing device 100 may be disposed on the first opening 92a to block or open the air flow into the guide duct 90. The first opening 92a may be disposed on one side of the guide body 91. The guide duct 90 may include a second opening 92b formed on the other side. The second opening 92b may be provided to allow air in the guide duct 90 to be discharged. The second opening 92b may be provided to allow air inside the guide duct 90 to be discharged. The second opening 92b may be provided to communicate with the cooking chamber 30. The second opening 92b may be provided to be connected to the plurality of communication holes 31 formed on the side plate 12b of the cooking chamber 30. The first opening 92a and the second opening 92b may be formed in different directions. For example, the first opening 92a may be arranged in one direction of the guide body 91, and the second opening 92b may be arranged in a direction perpendicular to the first opening 92a. For example, the guide body 91 may be provided in a substantially fan shape.

A lamp installation portion 93 may be disposed in the guide duct 90 to install a lamp 99 for forming illumination for the inside of the cooking chamber 30. The lamp installation portion 93 may be formed by opening at least a portion of an upper surface of the guide body 91. For example, the lamp 99 may be installed inside the guide duct 90 by penetrating through the lamp installation portion 93.

The opening and closing device 100 may be disposed in the guide duct 90. The opening and closing device 100 may be disposed in the guide body 91. The opening and closing device 100 may be disposed in the first opening 92a of the guide duct 90. The opening and closing device 100 may be configured to open and close the first opening 92a of the guide duct 90. The opening and closing device 100 may be provided to be coupled to the guide body 91 to open and close the first opening 92a of the guide duct 90.

The opening and closing device 100 may include a cover 110, a motor 120, and a connecting member 140. The opening and closing device 100 may include the cover 110. The cover 110 may be rotatably installed within the guide duct 90 to limit air movement to the guide duct 90. The cover 110 may be provided to correspond to the first opening 92a. The cover 110 may be configured to be rotatably moved by the motor 120. The cover 110 may include a guide slot 112 provided at a lower portion thereof. The guide slot 112 may be provided to be connected to the motor 120 via the connecting member 140. The guide slot 112 may be formed by cutting at least a portion of the lower portion of the cover 110. The guide slot 112 may be formed long in a horizontal direction of the cover 110 at a lower end of the cover 110. A second connecting portion 142 of the connecting member 140 may be connected to the guide slot 112.

The connecting member 140 may be provided to connect between the cover 110 and the motor 120. The connecting member 140 may include a first connecting portion 141 and the second connecting portion 142. The first connecting portion 141 may be provided at a lower portion of the connecting member 140. The second connecting portion 142 may be provided at an upper portion of the connecting member 140. The first connecting portion 141 connected to the motor 120 may be provided at the lower portion of the connecting member 140. The second connecting portion 142 connected to the cover 110 may be provided at the upper portion of the connecting member 140. The first connecting portion 141 and the second connecting portion 142 may be formed integrally with each other.

The motor 120 may include a motor shaft 121. The first connecting portion 141 of the connecting member 140 may be coupled to the motor shaft 121 of the motor 120. As the motor shaft 121 of the motor 120 is coupled to the first connecting portion 141, the connecting member 140 may rotate together with the motor shaft 121 when the motor shaft 121 rotates. When the motor shaft 121 rotates, the connecting member 140 may also rotate together by the first connecting portion 141 connected to the motor shaft 121. When the connecting member 140 rotates, the second connecting portion 142 may also rotate together. The second connecting portion 142 may be formed in a substantially cylindrical shape. The second connecting portion 142 in the shape of a cylinder may be coupled to the guide slot 112 of the cover 110, and thus the cover 110 may rotate and move along the guide slot 112 by rotation of the second connecting portion 142.

The cover 110 may include a rotation shaft coupling portion 111 provided to serve as a center of rotation. The rotation shaft coupling portion 111 may be disposed at one end of one side of the cover 110. The rotation shaft coupling portion 111 may be rotatably coupled to the guide duct 90 by a rotation shaft 151. A cover rotation shaft coupling portion 96 to which the rotation shaft 151 is coupled may be disposed at the guide duct 90. The cover rotation shaft coupling portion 96 may be disposed on upper and lower surfaces of the guide duct 90, respectively. The cover rotation shaft coupling portion 96 may be positioned adjacent to the first opening 92a of the guide duct 90. The cover rotation shaft coupling portion 96 may be provided to allow the rotation shaft 151 penetrating the rotation shaft coupling portion 111 of the cover 110 to be coupled and fixed thereto.

The cover 110 may rotate about to the rotation shaft 151 coupled to the cover rotation shaft coupling portion 96 provided adjacent to the first opening 92a of the guide duct 90. For example, the cover 110 may be configured to be rotatable about the rotation shaft 151 coupled to the cover rotation shaft coupling portion 96. The cover 110 may be configured to be rotatable by the motor 120.

The opening and closing device 100 may be installed at a position adjacent to the first opening 92a of the guide duct 90 to open and close the first opening 92a. The cover rotation shaft coupling portion 96 for rotatably coupling the cover 110 of the opening and closing device 100 may be disposed in the guide duct 90. A motor installation portion 94 for installing the motor 120 configured to rotate the cover 110 of the opening and closing device 100 may be disposed in the guide duct 90. The cover rotation shaft coupling portion 96 and the motor installation portion 94 may be disposed in the guide body 91. For example, the cover rotation shaft coupling portion 96 may be disposed on the upper and lower surfaces of the guide body 91, respectively. For example, the cover rotation shaft coupling portion 96 may be disposed on the upper and lower surfaces of the guide body 91 adjacent to the first opening 92a, respectively. For example, the motor installation portion 94 may be provided on the lower surface of the guide body 91. For example, the motor installation portion 94 may be disposed on the lower surface of the guide body 91 adjacent to the first opening 92a.

As the second connecting portion 142 penetrating the motor installation portion 94 is coupled to the guide slot 112 of the cover 110, the connecting member 140 may transmit a rotational movement of the motor 120 to the cover 110 and thus the cover 110 may open or close the first opening 92a.

The opening and closing device 100 may further include a switch 130 configured to limit movement of the cover 110. The switch 130 may be mounted on the motor 120 to limit the movement of the cover 110. For example, the switch 130 may be configured to limit rotational movement of the cover 110.

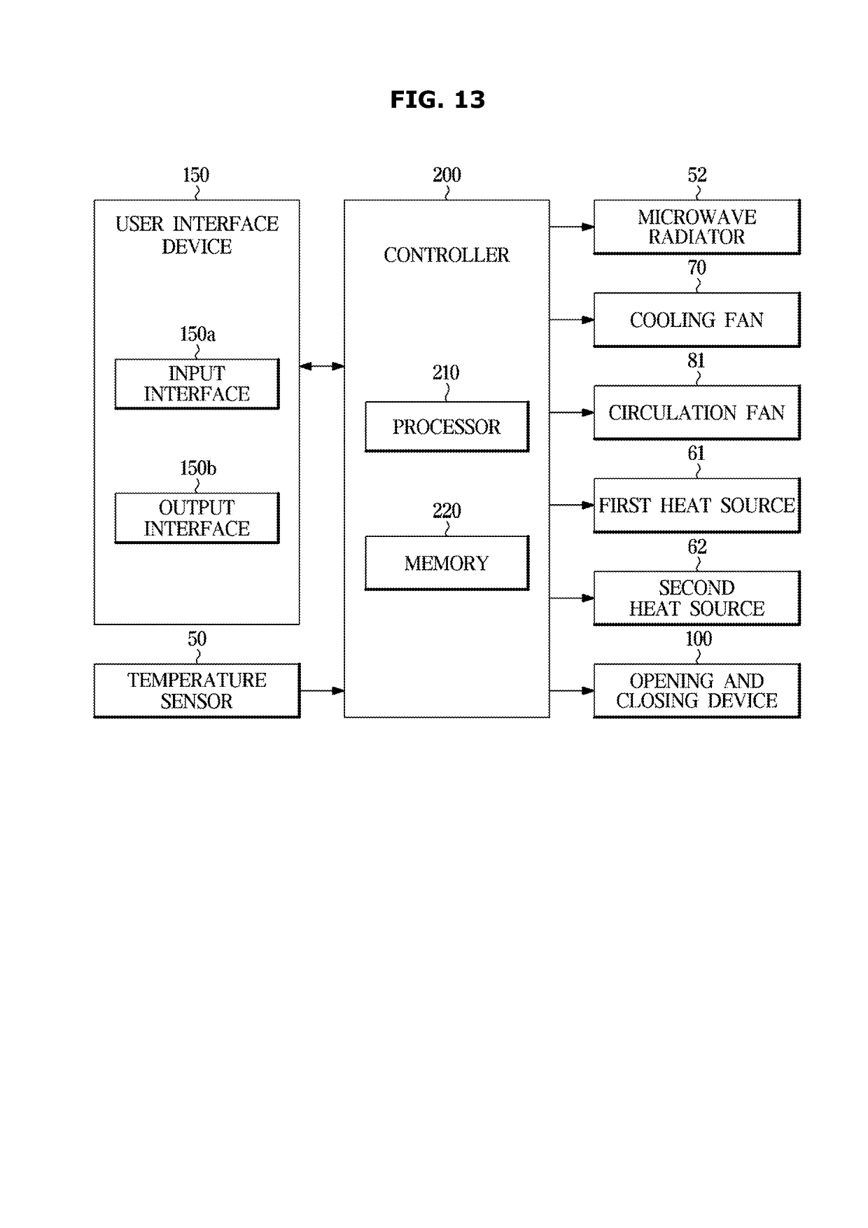

For example, in a range mode, the cover 110 of the opening and closing device 100 may be rotated by the motor 120 from the first opening 92a of the guide duct 90 to a first position P1. For example, in the range mode in which a cooking operation is performed using the microwave radiator 52, a controller 200 (refer to FIG. 13) may drive the motor 120 of the opening and closing device 100 to rotate the cover 110 to the first position P1 so as to open the guide duct 90.

When the opening and closing device 100 is rotated to the first position P1 and the first opening 92a of the guide duct 90 is opened, cold air may be introduced into the electrical component room 40 by the cooling fan 70 through the first opening 92a, and the cold air introduced into the electrical component room 40 may move to the cooking chamber 30 through the first opening 92a of the guide duct 90 so as to remove moisture inside the cooking chamber 30.

As for the range mode that radiates electromagnetic waves to cook food, the principle is to heat the food by causing water molecules in the food to vibrate through the microwave radiator 52, and thus moisture in the food may be released. Accordingly, moisture may accumulate inside the cooking chamber 30. Therefore, the opening and closing device 100 may open the cover 110 to supply air into the cooking chamber 30. As a result, moisture inside the cooking chamber 30 may be removed.

By removing moisture inside the cooking chamber 30, a user can check the inside of the cooking chamber 30.

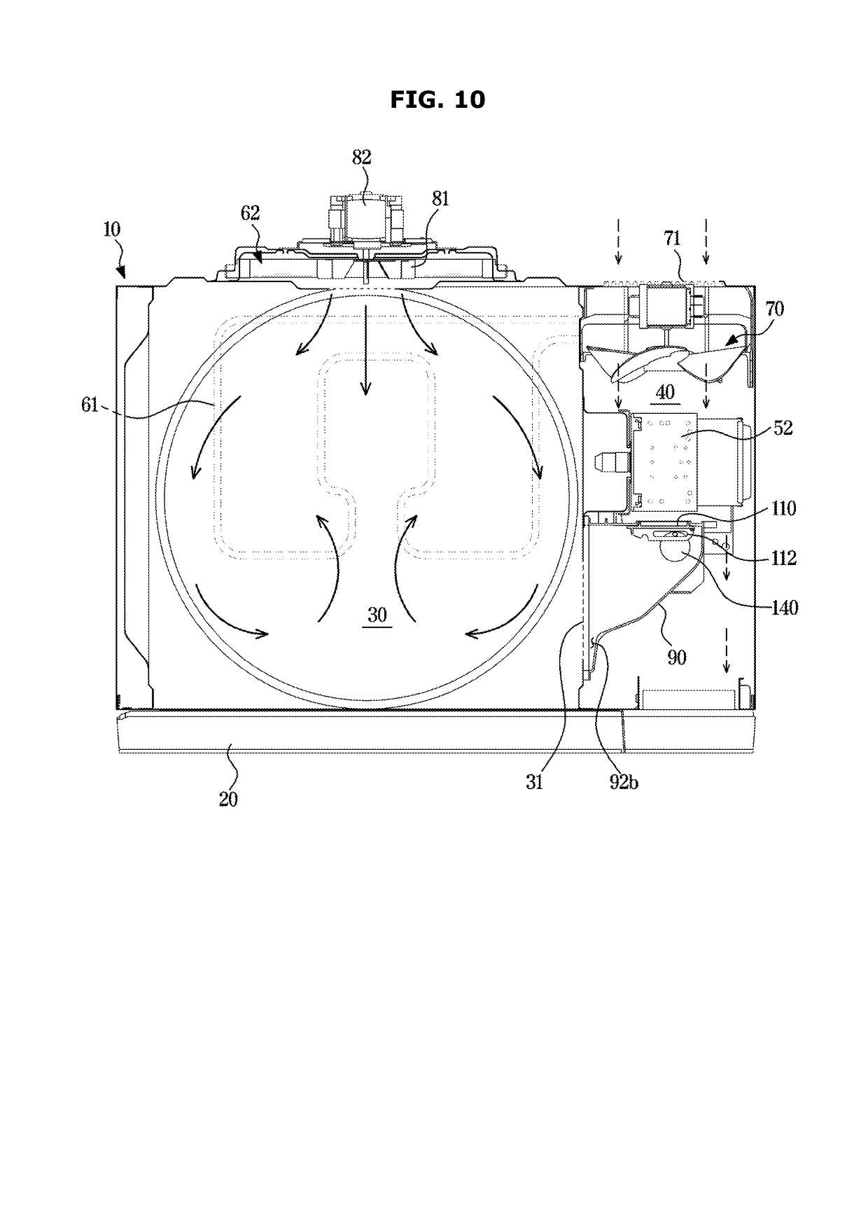

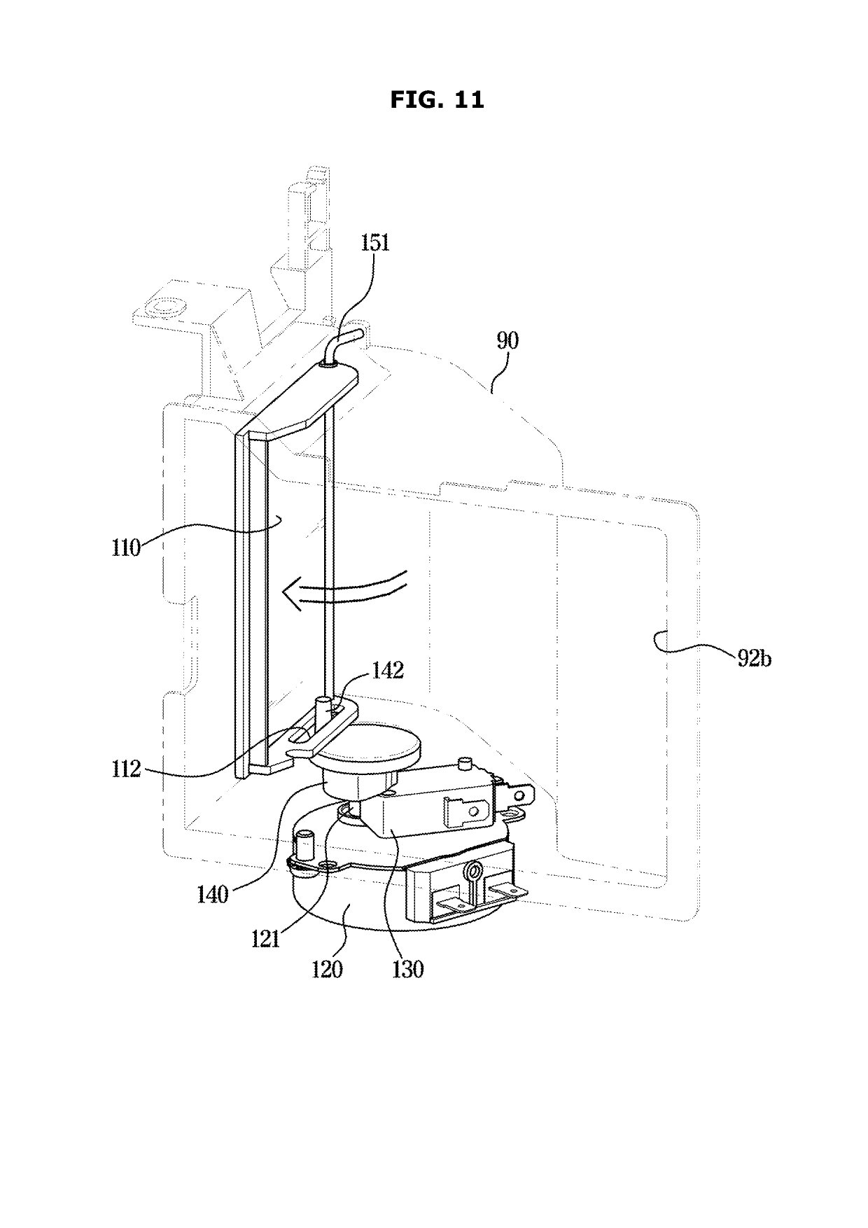

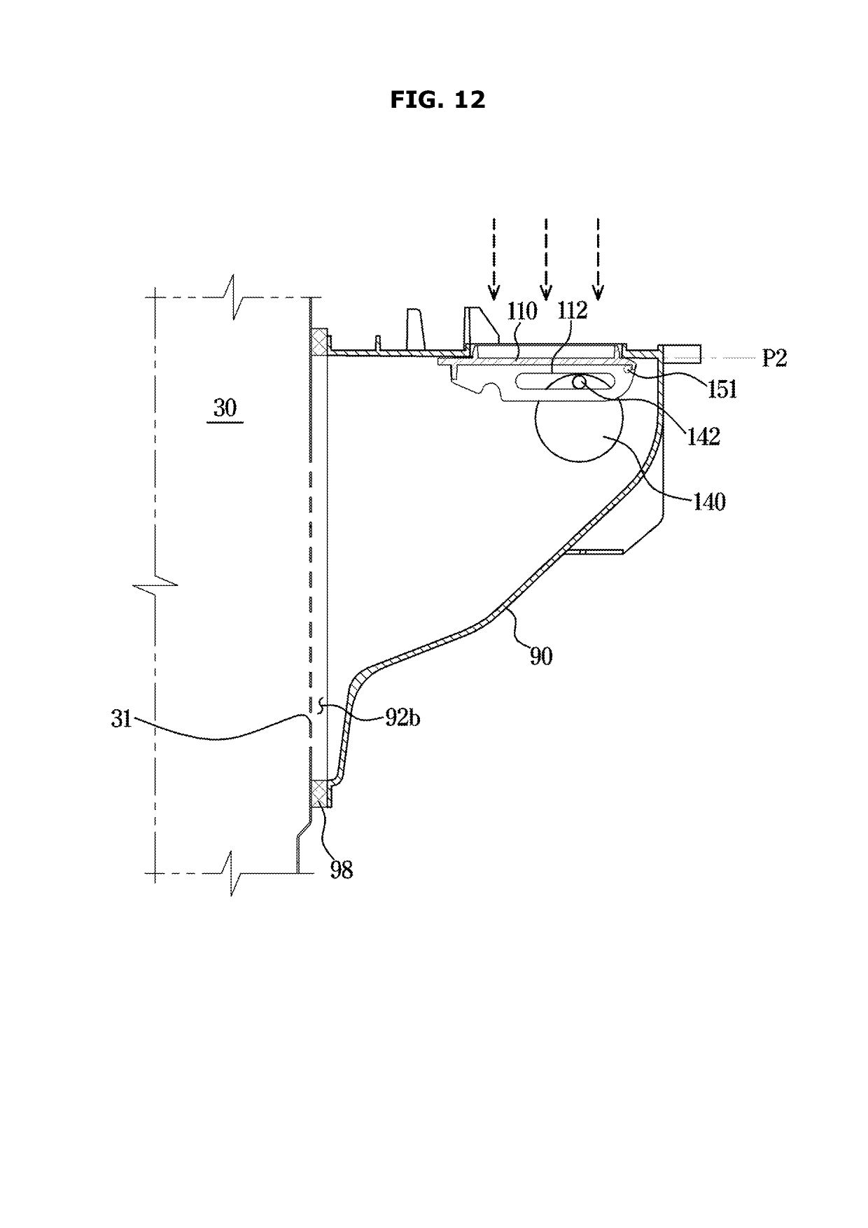

FIG. 10 is a view illustrating the air flow state according to the inflow of the outside air when the guide duct is closed by the opening and closing device according to an embodiment of the disclosure. FIG. 11 is a view illustrating the operating state of the opening and closing device illustrated in FIG. 10 according to an embodiment of the disclosure. FIG. 12 is a view illustrating the air flow due to the operation of the opening and closing device illustrated in FIG. 10 according to an embodiment of the disclosure. Hereinafter a description of the components the same as the above description will be omitted.

Referring to FIGS. 10 to 12, the opening and closing device 100 may block air from entering the guide duct 90 by allowing the cover 110 to be located at a second position P2.

The cooking apparatus 1 may include a grill mode in which a cooking operation is performed using the first heat source 61, an oven mode in which the cooking operation is performed using the second heat source 62, and/or an air-frying mode in which the cooking operation is performed using both the first heat source 61 and the second heat source 62. For example, in the air-frying mode, the cooking operation may be performed using the upper second heat source 62b of the second heat source 62 according to a set temperature, the cooking operation may be performed using the lower second heat source 62a of the second heat source 62, or the cooking operation may be performed using both the upper second heat source 62b and the lower second heat source 62a of the second heat source 62, simultaneously.

In the case of the air-frying mode using the first heat source 61 and/or the second heat source 62 in the cooking chamber 30, heat inside the cooking chamber 30 is required to be trapped to the cooking chamber 30. The air-frying mode is required to remove moisture from food using hot air and induce a Maillard reaction on a surface of the food to generate a crispy layer. In the air-frying mode, the first heat source 61 may dry moisture of food located at the upper portion while preheating. In the air-frying mode, the upper second heat source 62b and the lower second heat source 62a may be driven to generate convection hot air inside the cooking chamber 30 so as to dry the moisture of the food, and strong hot may be generated by the second heat source 62 with strong straightness.

In the air-frying mode, the cover 110 of the opening and closing device 100 may be positioned at the second position P2 to close the first opening 92a of the guide duct 90. For example, in the case of the air-frying mode in which the cooking operation is performed using the first heat source 61 and the second heat source 62, the controller (refer to FIG. 13) may drive the motor 120 of the opening and closing device 100 to move the cover 110 to the second position P2 so as to close the guide duct 90.

When the cover 110 of the opening and closing device 100 is in the second position P2, and the first opening 92a of the guide duct 90 is closed, inflow of cold air into the cooking chamber 30 is blocked by the closed guide duct 90. The cold air introduced into the electrical component room 40 by the cooling fan 70 may cool the main body 10 and the internal components of the electrical component room 40.

Therefore, in the air-frying mode, heat loss caused by cold air flowing into the cooking chamber 30 may be minimized, and a surface temperature of the main body 10 and temperatures of internal components may be prevented from increasing.

FIG. 13 illustrates a control block diagram of the cooking apparatus according to an embodiment of the disclosure.

Referring to FIG. 13, the cooking apparatus 1 according to one embodiment may include a user interface device 150, a temperature sensor 50, the microwave radiator 52, the cooling fan 70, the circulation fan 81, the first heat source 61, the second heat source 62, the opening and closing device 100, and the controller 200.

The user interface device 150 may include an output interface 150b and an input interface 150a.

At least one output interface 150b may transmit various information related to the operation of the cooking apparatus 1 to a user by generating sensory information.

For example, the at least one output interface 150b may transmit information related to settings of the cooking apparatus 1 and an operating time of the cooking apparatus 1 to a user. Information related to the operation of the cooking apparatus 1 may be output by a display 51, an indicator, and/or a voice. The at least one output interface 150b may include a liquid crystal display (LCD) panel, an indicator, a light emitting diode (LED) panel, and a speaker.

According to one embodiment, the at least one output interface 150b may include a display.

According to one embodiment, the at least one output interface 150b may output sensory information (for example, visual information and auditory information) related to the control of the cooking apparatus 1.

The at least one input interface 150a may convert sensory information received from a user into an electrical signal.

For example, the at least one input interface 150a may include the manipulating portion 18aand/or the button 18b described above.

The at least one input interface 150a may include a button for receiving user input related to the cooking apparatus 1.

Each button may include a visual indicator (for example, text and an icon) that indicates a function thereof.

According to one embodiment, the at least one input interface 150a may receive a mode selection input for selecting a cooking mode (or driving mode) of the cooking apparatus 1.

The cooking mode (or driving mode) of the cooking apparatus 1 may include the air-frying mode, the range mode, the oven mode, and/or the grill mode.

As mentioned above, the air-frying mode is a mode that cooks food using the first heat source 61 and the second heat source 62.

Particularly, the air-frying mode is a mode that generates a crispy texture of food without using much oil by circulating high-temperature hot air with the circulation fan 81 to cook food.

Particularly, the air-frying mode is a method that cooks food by circulating high-temperature hot air with the circulation fan 81 and a mode that generates a crispy texture of food without using much oil.

In the air-frying mode, it is required to prevent outside air from entering the cooking chamber 30 to ensure a crispy texture of the food. In addition, because high-temperature hot air is required in the air-frying mode, it is required to prevent the high-temperature hot air from heating the main body 10 and causing damage to various components or injury to a user.

However, according to the conventional manner, when the cooling fan is driven, it is difficult to prevent outside air from entering the inside of the cooking chamber, and when the cooling fan is not driven, it is difficult to prevent the main body from being heated.

The range mode corresponds to a mode for cooking food using the microwave radiator 52.

Particularly, the range mode is a method that heats food from the inside by vibrating water molecules inside the food using electromagnetic waves and an effective mode for quickly heating or thawing moist food.

In the range mode, the food is heated by vibrating water molecules, and thus a lot of moisture is generated inside the cooking chamber 30. Accordingly, there is a need to prevent a situation in which a user cannot observe the inside of the cooking chamber 30.

The oven mode corresponds to a mode for cooking food using the second heat source 62.

Particularly, the oven mode is a method of evenly heating the entire interior of the cooking chamber 30 using the second heat source 62 and an effective mode for cooking food by transferring heat from the outside to the inside of the food.

In the oven mode, because the entire interior of the cooking chamber 30 needs to be heated evenly, it is required to prevent outside air from flowing into the cooking chamber 30.

However, according to the conventional manner, when the cooling fan is driven, it is difficult to prevent outside air from entering the interior of the cooking chamber, and when the cooling fan is not driven, it is difficult to prevent the main body from being heated.

The grill mode corresponds to a mode for cooking food using the first heat source 61.

Particularly, the grill mode is a mode that is effective in directly heating a surface of food by using the first heat source 61 for heating.

In the grill mode, because the heat supplied by the first heat source 61 is concentrated on the surface of the food, it is required to circulate the air inside the cooking chamber 30.

According to one embodiment, the at least one input interface 150a may receive a mode setting input for settings related to a selected cooking mode (or driving mode).

The mode setting input is an input regarding various settings related to the cooking mode selected by the mode selection input.

For example, the mode setting input may include a time setting input for setting a cooking time (or operating time) of the selected cooking mode, and a temperature setting input for setting a cooking temperature of the selected cooking mode.

According to one embodiment, the at least one input interface 150a may receive a start input to start a cooking mode for which selection and setting are completed.

The controller 200 may control the operation of the cooking apparatus 1 by processing the user input received through the input interface 150a.

For example, the controller 200 may control various components of the cooking apparatus 1 (for example, the microwave radiator 52, the cooling fan 70, the circulation fan 81, the first heat source 61, the second heat source 62 and/or the opening and closing device 100) to perform the selected cooking mode based on the selected setting based on receiving the start input.

The at least one input interface 150a may include a tact switch, a push switch, a slide switch, a toggle switch, a micro switch, a touch switch, a touch pad, a touch screen, a jog dial, and/or a microphone.

In the disclosure, 'button' may be replaced with a User Interface (UI) element, a tact switch, a push switch, a slide switch, a toggle switch, a micro switch, a touch switch, a touch pad, a touch screen, a jog dial, and/or a microphone.

The temperature sensor 50 may measure the temperature of the cooking chamber 30.

The temperature sensor 50 may be installed in various locations inside the main body 10. For example, the temperature sensor 50 may be installed inside the cooking chamber 30, but the location of the temperature sensor 50 is not limited thereto.

The temperature sensor 50 may transmit information related to the measured temperature of the cooking chamber 30 to the controller 200.

The controller 200 may include a processor 210 and memory 220. The processor 210 may be hardware and include logic circuits and arithmetic circuits. The processor 210 may control components of the cooking apparatus 1, which are electrically connected, using programs, instructions, and/or data stored in the memory 220 for the operation of the cooking apparatus 1. The controller 200 may be implemented as a control circuit including circuit elements such as capacitors, inductors, and resistors. The processor 210 and the memory 220 may be implemented as separate chips or as a single chip. In addition, the controller 200 may include a plurality of processors and a plurality of memories.

The memory 220 may store programs, applications, and/or data for the operation of the cooking apparatus 1, and may store data generated by the processor 210. The memory 220 may include non-volatile memory such as Read Only Memory (ROM) and flash memory for storing data for a long period of time. The memory 220 may include volatile memory such as Static Random Access Memory (S-RAM) and Dynamic Random Access Memory (D-RAM) for temporarily storing data.

According to one embodiment, the controller 200 may control various configurations of the cooking apparatus 1 according to various cooking modes.

In the disclosure, driving a specific configuration may represent turning on the specific configuration, and terminating or stopping the driving of the specific configuration may represent turning off the specific configuration.

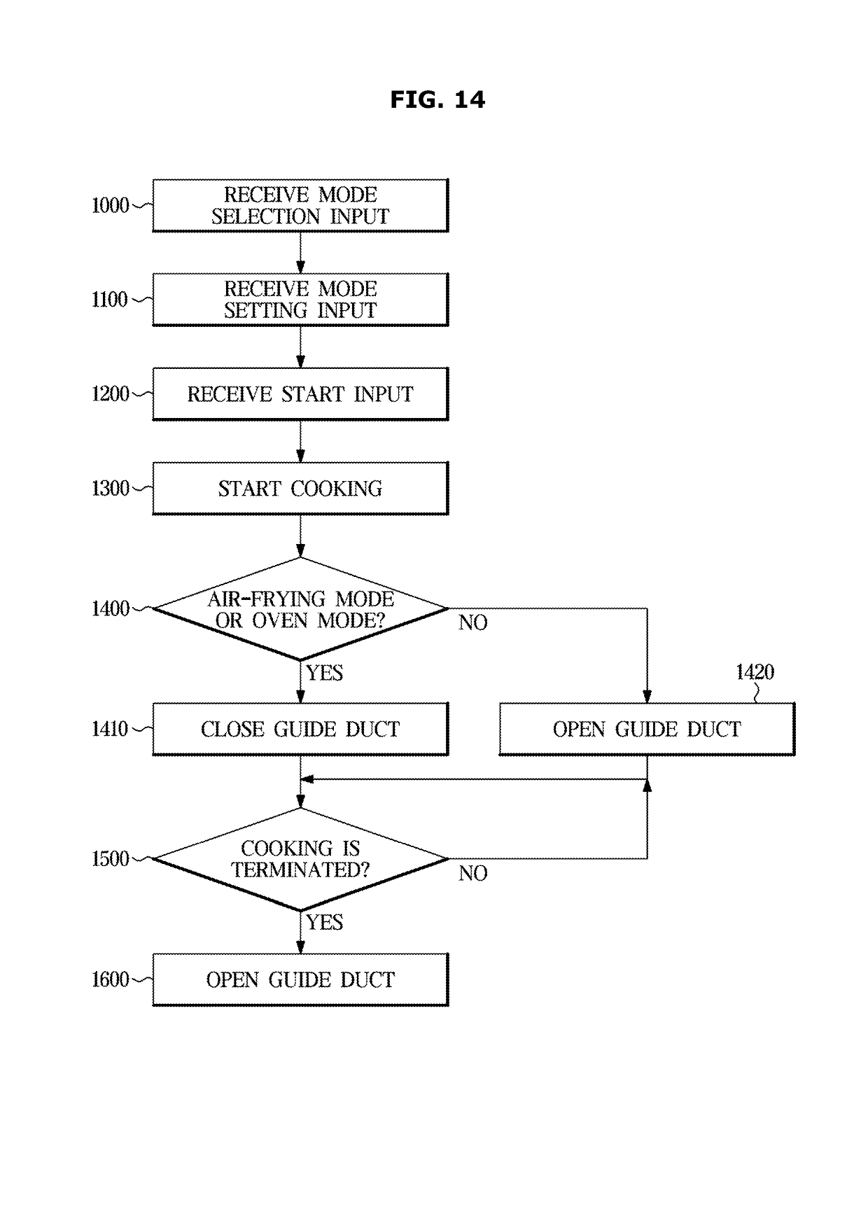

FIG. 14 is a flowchart illustrating whether the guide duct is opened or not according to a driving mode of the cooking apparatus according to an embodiment of the disclosure.

Referring to FIG. 14, the controller 200 may receive a mode selection input for selecting a cooking mode (or driving mode) of the cooking apparatus 1 in operation 1000. For example, the controller 200 may receive the mode selection input through the at least one input interface 150a.

The controller 200 may receive a mode setting input for settings related to the selected cooking mode (or driving mode) in operation 1100. For example, the controller 200 may receive the mode setting input through the at least one input interface 150a.

The controller 200 may receive a start input to start the cooking mode for which selection and setting are completed in operation 1200. For example, the controller 200 may receive the start input through the at least one input interface 150a.

The controller 200 may start the selected cooking mode in response to receiving the start input for starting the cooking mode for which selection and setting are completed in operation 1300.

Starting the selected cooking mode may include controlling various components of the cooking apparatus 1 (for example, the microwave radiator 52, the cooling fan 70, the circulation fan 81, the first heat source 61, the second heat source 62 and/or the opening and closing device 100) based on the selected cooking mode and cooking settings.

The controller 200 may control the opening and closing device 100 to close the guide duct 90 based on the air-frying mode and/or the oven mode being selected among the plurality of cooking modes (yes in operation 1400).

Based on a mode other than the air-frying mode and/or oven mode (for example, the range mode and/or the grill mode) being selected among the plurality of cooking modes (no in operation 1400), the controller 200 may control the opening and closing device 100 to open the guide duct 90 in operation 1420.

Controlling the opening and closing device 100 to open the guide duct 90 may also represent not outputting any control signal to the opening and closing device 100 in response to the guide duct 90 being in an open state.

For example, the controller 200 may not output any control signal to the opening and closing device 100 in response to the selected cooking mode corresponding to a mode (for example, the range mode and/or the grill mode) other than the air-frying mode or oven mode.

Based on the selected cooking mode being terminated (yes in operation 1500), the controller 200 may control the opening and closing device 100 to open the guide duct 90 in operation 1600.

For example, the controller 200 may control the opening and closing device 100 to close the guide duct 90 based on receiving the start input in response to the selected cooking mode corresponding to the air-frying mode or the oven mode in operation 1410, and may control the opening and closing device 100 to open the guide duct 90 based on the cooking mode being terminated in operation 1600.

According to one embodiment, in response to the selected cooking mode corresponding to the air-frying mode or the oven mode, the controller 200 may drive the cooling fan 70 based on receiving the start input. For example, the controller 200 may drive the cooling fan 70 at a preset maximum rotation speed based on the air-frying mode or oven mode being started.

According to one embodiment, the controller 200 may drive the cooling fan 70 at a maximum first rotation speed in the range mode and/or grill mode. Particularly, the controller 200 may drive the cooling fan 70 at the preset maximum rotation speed in the air-frying mode or oven mode, but the first rotation speed may be less than the preset maximum rotation speed.

The termination of the selected cooking mode may represent that a cooking time, which is set according to the cooking settings, elapses. For example, the controller 200 may terminate the selected cooking mode based on the cooking time, which is set according to the cooking settings, elapsing after the start of the cooking mode.

According to the disclosure, in response to the start of the air-frying mode and/or oven mode, outside air may be prevented from entering the interior of the cooking chamber 30 during cooking. In addition, as will be described later, according to the disclosure, in response to the start of the air-frying mode and/or oven mode, the cooling fan 70 may be driven while the guide duct 90 is closed, thereby preventing the main body 10 from being heated.

Hereinafter the operation of the controller 200 in each of the plurality of cooking modes will be described.

The controller 200 may drive the microwave radiator 52 based on the range mode being started, and stop the driving of the microwave radiator 52 in response to the range mode being terminated.

The controller 200 may drive the cooling fan 70 based on the range mode being started, and stop the driving of the cooling fan 70 in response to the range mode being terminated.

The controller 200 may control the opening and closing device 100 to maintain the open state of the guide duct 90 based on the range mode being started.

In the embodiment as illustrated in FIG. 14, the controller 200 may control the opening and closing device 100 to open the guide duct 90 based on all cooking modes being terminated. In this case, that the controller 200 controls the opening and closing device 100 to maintain the open state of the guide duct 90 based on the range mode being started may represent not outputting any control signal to the opening and closing device 100.

Meanwhile, according to various embodiments, the controller 200 may control the opening and closing device 100 to close the guide duct 90 based on all cooking modes being terminated, or may control the opening and closing device 100 to open or close the guide duct 90 depending on the cooking mode at the start of the cooking mode regardless of the termination of the cooking mode.

According to one embodiment, the controller 200 may determine a cooking mode that is most frequently used by a user based on user's cooking mode usage history, and at the termination of all cooking modes, the controller 200 may open or close the guide duct 90 in response to the cooking mode most frequently used by the user.

Hereinafter for convenience of description, it is assumed that the controller 200 controls the opening and closing device 100 to open the guide duct 90 based on the cooking mode being terminated.

According to one embodiment, when the cooking apparatus 1 is not in use, the interior of the cooking chamber 30 may be ventilated as the open state of the guide duct 90 is always maintained.

According to the disclosure, in the range mode, moisture may be prevented from accumulating inside the cooking chamber 30 by opening the guide duct 90 and driving the cooling fan 70.

The controller 200 may drive the second heat source 62 based on the oven mode being started, and stop the driving of the second heat source 62 in response to the oven mode being terminated.

The controller 200 may drive the cooling fan 70 based on the oven mode being started, and stop the driving of the cooling fan 70 in response to the oven mode being terminated.

The controller 200 may control the opening and closing device 100 to close the guide duct 90 based on the oven mode being started.

According to the disclosure, in the oven mode, by closing the guide duct 90 and driving the cooling fan 70, it is possible to prevent outside air from flowing into the cooking chamber 30 while preventing the main body 10 from being heated.

The controller 200 may drive the first heat source 61 based on the grill mode being started, and stop the driving of the first heat source 61 in response to the grill mode being terminated.

The controller 200 may drive the cooling fan 70 based on the grill mode being started, and stop the driving of the cooling fan 70 in response to the grill mode being terminated.

The controller 200 may control the opening and closing device 100 to open the guide duct 90 based on the grill mode being started.

According to the disclosure, in the grill mode, by opening the guide duct 90 and driving the cooling fan 70, it is possible to assist air inside the cooking chamber 30 to flow and it is possible to prevent moisture from forming inside the cooking chamber 30.

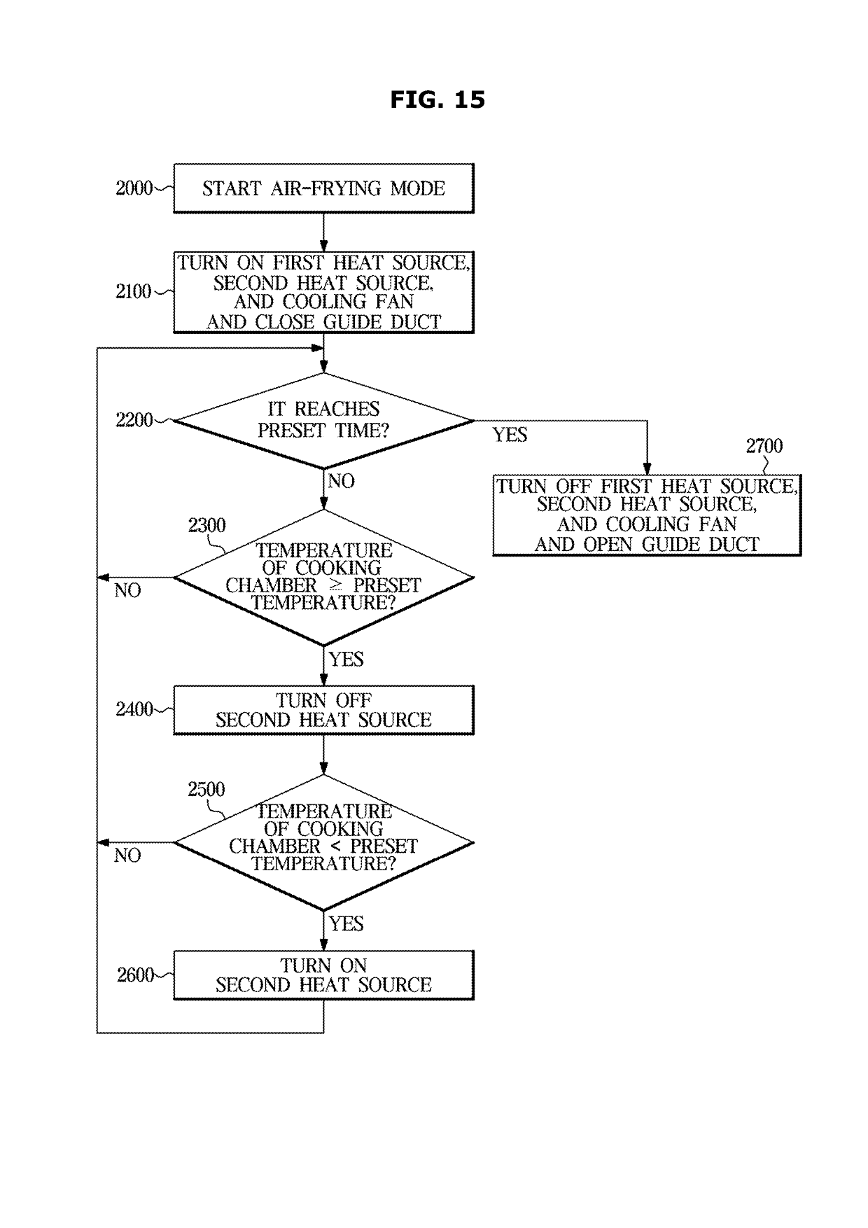

FIG. 15 is a flowchart illustrating operation of components of the cooking apparatus when the cooking apparatus operates in an air-frying mode according to an embodiment of the disclosure.

Referring to FIG. 15, based on the air-frying mode being started in operation 2000, the controller 200 may drive the first heat source 61, the second heat source 62, and the cooling fan 70 and control the opening and closing device 100 to close the guide duct 90 in operation 2100. Although not shown in the drawing, the controller 200 may drive the circulation fan 81 based on the air-frying mode being started.

The circulation fan 81 may allow air heated by the first heat source 61 and/or the second heat source 62 to be supplied into the interior of the cooking chamber 30.

The controller 200 may terminate the air-frying mode in response to a set time elapsing after the start of the air-frying mode (yes in operation 2200).

The set time may represent a set cooking time according to the time setting input.

The controller 200 may cook food in the air-frying mode until the set time elapses after the start of the air-frying mode.

According to one embodiment, based on the temperature of the cooking chamber 30 reaching a preset temperature after the start of the air-frying mode (yes in operation 2300), the controller 200 may stop driving of the second heat source 62 until the temperature of the cooking chamber 30 falls below the preset temperature in operation 2400.

The preset temperature may represent the set temperature according to the temperature setting input.

Meanwhile, in one embodiment, the controller 200 may maintain a driving state of the first heat source 61 even when the temperature of the cooking chamber 30 reaches the preset temperature after the start of the air-frying mode. Maintaining the driving state of the first heat source 61 may represent not turning off the first heat source 61.

For example, the controller 200 may turn off only the second heat source 62 between the first heat source 61 and the second heat source 62 based on the temperature of the cooking chamber 30 reaching the preset temperature after the start of the air-frying mode.

For example, the controller 200 may drive the first heat source 61 from a start point of time to a termination point of time of the air-frying mode.

According to the conventional manner, when the first heat source is driven in a case in which the temperature of the cooking chamber reaches the preset temperature, it is difficult to prevent the temperature of the cooking chamber from rising. Accordingly, it is required to turn off the first heat source and the second heat source.

On the other hand, according to the disclosure, at the start of the air-frying mode, the cooling fan 70 may be driven after the guide duct 90 is closed, and thus it is possible to prevent the main body 10 from being heated (or to prevent the temperature of the cooking chamber 30 from rising). Accordingly, there is no need to turn off the first heat source 61 even when the temperature of the cooking chamber 30 reaches the preset temperature.

According to the disclosure, high cooking performance may be secured by continuously driving the first heat source 61.

According to one embodiment, after stopping the driving of the second heat source 62 based on the temperature of the cooking chamber 30 reaching the preset temperature, the controller 200 may resume the driving of the second heat source 62 in operation 2600 based on the temperature of the cooking chamber 30 falling below the preset temperature (yes in operation 2500).

According to the disclosure, in response to the temperature of the cooking chamber 30 falling below the preset temperature even though the first heat source 61 is continuously driven, the temperature of the cooking chamber 30 may be quickly maintained at the user's set temperature by resuming the driving of the second heat source 62.

Based on the operating time of the air-frying mode reaching a preset time (the termination of the air-frying mode) (yes in operation 2200), the controller 200 may stop the driving of the first heat source 61, the second heat source 62, and the cooling fan 70 and control the opening and closing device 100 to open the guide duct 90 in operation 2700. Although not shown in the drawings, the controller 200 may also stop the driving of the circulation fan 81 based on the termination of the air-frying mode.

According to various embodiments, the main body 10 may remain heated immediately after the air-frying mode terminates. Accordingly, the cooking apparatus 1 according to one embodiment may perform an operation to cool the main body 10 for a predetermined period of time after the air-frying mode terminates.

According to one embodiment, the controller 200 may stop the driving of the first heat source 61 and the second heat source 62 in response to the operating time of the air-frying mode reaching a preset time, but may stop the driving of the cooling fan 70 after maintaining the driving of the cooling fan 70 for a predetermined period of time.

According to one embodiment, the controller 200 may stop the driving of the first heat source 61 and the second heat source 62 in response to the operating time of the air-frying mode reaching the preset time, but control the opening and closing device 100 to open the guide duct 90 after maintaining the closure of the guide duct 90 for a predetermined period of time.

For example, the controller 200 may immediately stop the driving of the first heat source 61 and the second heat source 62 in response to the operating time of the air-frying mode reaching the preset time, and drive the cooling fan 70 while maintaining the closure of the guide duct 90 for a predetermined period of time.

According to the disclosure, it is possible to prevent a user from being injured due to the hot main body 10 when immediately after the air-frying mode.

A cooking apparatus 1 according to one embodiment may include: a main body 10 including a cooking chamber 30; a first heat source 61 disposed in the cooking chamber 30 to generate radiant heat; a second heat source 62 disposed in the cooking chamber 30 to generate convection heat; a microwave radiator 52 configured to generate microwaves inside the cooking chamber 30; an electrical component room 40 partitioned from the cooking chamber 30 and provided to receive the microwave radiator 52; a cooling fan 70 configured to draw in outside air and discharge the outside air to the electrical component room 40 so as to cool the electrical component room 40; a guide duct 90 provided to guide air discharged from the cooling fan 70 into the cooking chamber 30; and an opening and closing device 100 configured to open and close the guide duct 90. According to the disclosure, a cooking time may be reduced and thus a cooking apparatus with improved cooking performance may be provided.

The opening and closing device 100 may include a cover 110 rotatably installed within the guide duct to limit air movement into the guide duct 90, a motor 120 configured to rotate the cover 110, and a connecting member 140 connecting the cover 110 and the motor 120.

The opening and closing device 100 may further include a switch 130 configured to limit movement of the cover 110.

The main body 10 may include an air intake port 71 formed to allow the outside air to be drawn in. The air intake port 71 may be disposed behind the electrical component room 40.

The cooking apparatus 1 may further include memory 220 storing instructions, and at least one processor 210 communicatively coupled to the first heat source, the second heat source, the microwave radiator, the cooling fan, the opening and closing device, and the memory. The instructions, when executed by the at least one processor individually or collectively, may cause the cooking apparatus to close the guide duct 90 based on an air-frying mode or an oven mode, among a plurality of modes, being started.

The instructions, when executed by the at least one processor individually or collectively, may cause the cooking apparatus to open the guide duct 90 based on the air-frying mode or the oven mode being terminated.

The instructions, when executed by the at least one processor individually or collectively, may cause the cooking apparatus to maintain an open state of the guide duct 90 based on a range mode or a grill mode, among the plurality of modes, being started.

The instructions, when executed by the at least one processor individually or collectively, may cause the cooking apparatus to drive the cooling fan 70 based on the air-frying mode or the oven mode being terminated.

The instructions, when executed by the at least one processor individually or collectively, may cause the cooking apparatus to drive the cooling fan 70 at a preset maximum rotation speed based on the air-frying mode or the oven mode being started.

The cooking apparatus 1 may further include memory 220 storing instructions, and at least one processor 210 communicatively coupled to the first heat source, the second heat source, the microwave radiator, the cooling fan, the opening and closing device, and the memory. The instructions, when executed by the at least one processor individually or collectively, may cause the cooking apparatus to, based on an air-frying mode, among a plurality of modes, being started, drive the first heat source 61, the second heat source 62, and the cooling fan 70, and, based on the air-frying mode being started, control the opening and closing device 100 to close the guide duct 90.

The cooking apparatus 1 may further include a temperature sensor, configured to measure a temperature of the cooking chamber, communicatively coupled to the at least one processor. The instructions, when executed by the at least one processor individually or collectively, may cause the cooking apparatus to, based on the temperature of the cooking chamber 30 reaching a preset temperature after the air-frying mode is started, stop the driving of the second heat source 62 until the temperature of the cooking chamber 30 falls below the preset temperature.

The instructions, when executed by the at least one processor individually or collectively, may cause the cooking apparatus to, based on an operating time of the air-frying mode reaching a preset time, stop the driving of the first heat source 61, the second heat source 62, and the cooling fan 70, and, based on the operating time of the air-frying mode reaching the preset time, open the guide duct 90.

The instructions, when executed by the at least one processor individually or collectively, may cause the cooking apparatus to, in response to the operating time of the air-frying mode reaching the preset time, stop the driving of the first heat source 61 and the second heat source 62, and, in response to the operating time of the air-frying mode reaching the preset time, stop the driving of the cooling fan 70 after maintaining the driving of the cooling fan 70 for a predetermined period of time.

The instructions, when executed by the at least one processor individually or collectively, may cause the cooking apparatus to, in response to the operating time of the air-frying mode reaching the preset time, stop the driving of the first heat source 61 and the second heat source 62, and in response to the operating time of the air-frying mode reaching the preset time, control the opening and closing device 100 to open the guide duct 90 after maintaining the closure of the guide duct 90 for a predetermined period of time.

A method performed by a cooking apparatus 1 according to one embodiment may include, based on an air-frying mode, among a plurality of modes, being started, driving the first heat source 61, the second heat source 62, and the cooling fan 70, and, based on the air-frying mode being started, closing the guide duct 90.

The method for may further include, based on a temperature of the cooking chamber 30 reaching a preset temperature after the start of the air-frying mode, stopping the driving of the second heat source 62 until the temperature of the cooking chamber 30 falls below the preset temperature.

The method may further include, based on an operating time of the air-frying mode reaching a preset time, stopping the driving of the first heat source 61, the second heat source 62, and the cooling fan 70, and, based on the operating time of the air-frying mode reaching the preset time, opening the guide duct 90.

The stopping of driving of the first heat source 61, the second heat source 62, and the cooling fan 70, based on the operating time of the air-frying mode reaching the preset time may include, in response to the operating time of the air-frying mode reaching the preset time, stopping the driving of the first heat source 61 and the second heat source 62, and, in response to the operating time of the air-frying mode reaching the preset time, stopping the driving of the cooling fan 70 after maintaining the driving of the cooling fan 70 for a predetermined period of time.

The stopping of driving of the first heat source 61, the second heat source 62, and the cooling fan 70, based on the operating time of the air-frying mode reaching the preset time may include, in response to the operating time of the air-frying mode reaching the preset time, stopping the driving of the first heat source 61 and the second heat source 62. The opening of the guide duct, based on the operating time of the air-frying mode reaching the preset time may include, in response to the operating time of the air-frying mode reaching the preset time, opening the guide duct 90 after maintaining the closure of the guide duct 90 for a predetermined period of time.

The control method for controlling the cooking apparatus 1 may further include closing the guide duct 90 based on an oven mode being started among the plurality of modes, and maintaining an open state of the guide duct 90 based on a range mode or a grill mode being started among the plurality of modes.

While the disclosure has been shown and described with reference to various embodiments thereof, it will be understood by those of skilled in the art that various changes in form and details may be made therein without departing from the spirit and scope of the disclosure as defined by the appended claims and their equivalents.

What is claimed is:

1. A cooking apparatus comprising:
a main body comprising a cooking chamber;
a first heat source disposed in the cooking chamber to generate radiant heat;
a second heat source disposed in the cooking chamber to generate convection heat;
a microwave radiator configured to generate microwaves inside the cooking chamber;
an electrical component room partitioned from the cooking chamber and provided to receive the microwave radiator;
a cooling fan configured to draw in outside air and discharge the outside air to the electrical component room so as to cool the electrical component room;
a guide duct provided to guide air discharged from the cooling fan into the cooking chamber; and
an opening and closing device configured to open and close the guide duct.

2. The cooking apparatus of claim 1, wherein the opening and closing device comprises:
a cover rotatably installed within the guide duct to limit air movement into the guide duct;
a motor configured to rotate the cover; and
a connecting member connecting the cover and the motor.

3. The cooking apparatus of claim 2, wherein the opening and closing device further comprises:
a switch configured to limit movement of the cover.

4. The cooking apparatus of claim 1,
wherein the main body comprises an air intake port formed to allow the outside air to be drawn in, and
wherein the air intake port is disposed behind the electrical component room.

5. The cooking apparatus of claim 1, further comprising:
memory storing instructions; and
at least one processor communicatively coupled to the first heat source, the second heat source, the microwave radiator, the cooling fan, the opening and closing device, and the memory,
wherein the instructions, when executed by the at least one processor individually or collectively, cause the cooking apparatus to:
close the guide duct based on an air-frying mode or an oven mode, among a plurality of modes, being started.

6. The cooking apparatus of claim 5, wherein the instructions, when executed by the at least one processor individually or collectively, cause the cooking apparatus to:
open the guide duct based on the air-frying mode or the oven mode being terminated.

7. The cooking apparatus of claim 5, wherein the instructions, when executed by the at least one processor individually or collectively, cause the cooking apparatus to:
maintain an open state of the guide duct based on a range mode or a grill mode, among the plurality of modes, being started.

8. The cooking apparatus of claim 5, wherein the instructions, when executed by the at least one processor individually or collectively, cause the cooking apparatus to:
drive the cooling fan based on the air-frying mode or the oven mode being terminated.

9. The cooking apparatus of claim 8, wherein the instructions, when executed by the at least one processor individually or collectively, cause the cooking apparatus to:
drive the cooling fan at a preset maximum rotation speed based on the air-frying mode or the oven mode being started.

10. The cooking apparatus of claim 1, further comprising:
memory storing instructions; and
at least one processor communicatively coupled to the first heat source, the second heat source, the microwave radiator, the cooling fan, the opening and closing device, and the memory,
wherein the instructions, when executed by the at least one processor individually or collectively, cause the cooking apparatus to:
based on an air-frying mode, among a plurality of modes, being started, drive the first heat source, the second heat source, and the cooling fan, and
based on the air-frying mode being started, close the guide duct.

11. The cooking apparatus of claim 10, further comprising:
a temperature sensor, configured to measure a temperature of the cooking chamber, communicatively coupled to the at least one processor,
wherein the instructions, when executed by the at least one processor individually or collectively, cause the cooking apparatus to:
based on the temperature of the cooking chamber reaching a preset temperature after the air-frying mode is started, stop the driving of the second heat source until the temperature of the cooking chamber falls below the preset temperature.

12. The cooking apparatus of claim 10, wherein the instructions, when executed by the at least one processor individually or collectively, cause the cooking apparatus to:
based on an operating time of the air-frying mode reaching a preset time, stop the driving of the first heat source, the second heat source, and the cooling fan, and
based on the operating time of the air-frying mode reaching the preset time, open the guide duct.

13. The cooking apparatus of claim 12, wherein the instructions, when executed by the at least one processor individually or collectively, cause the cooking apparatus to:
in response to the operating time of the air-frying mode reaching the preset time, stop the driving of the first heat source and the second heat source, and
in response to the operating time of the air-frying mode reaching the preset time, stop the driving of the cooling fan after maintaining the driving of the cooling fan for a predetermined period of time.

14. The cooking apparatus of claim 12, wherein the instructions, when executed by the at least one processor individually or collectively, cause the cooking apparatus to:
in response to the operating time of the air-frying mode reaching the preset time, stop the driving of the first heat source and the second heat source, and
in response to the operating time of the air-frying mode reaching the preset time, open the guide duct after maintaining the closure of the guide duct for a predetermined period of time.

15. A method performed by a cooking apparatus that includes a main body comprising a cooking chamber, a first heat source disposed in the cooking chamber to generate radiant heat, a second heat source disposed in the cooking chamber to generate convection heat, a microwave radiator configured to generate microwaves inside the cooking chamber, an electrical component room partitioned from the cooking chamber and provided to receive the microwave radiator, a cooling fan configured to draw in outside air and discharge the outside air to the electrical component room so as to cool the electrical component room, a guide duct provided to guide air discharged from the cooling fan into the cooking chamber, and an opening and closing device configured to open and close the guide duct, the method comprising:
based on an air-frying mode, among a plurality of modes, being started, driving the first heat source, the second heat source, and the cooling fan; and
based on the air-frying mode being started, closing the guide duct.

16. The method of claim 15, further comprising:
based on a temperature of the cooking chamber reaching a preset temperature after the air-frying mode is started, stopping the driving of the second heat source until the temperature of the cooking chamber falls below the preset temperature.

17. The method of claim 15, further comprising:
based on an operating time of the air-frying mode reaching a preset time, stopping the driving of the first heat source, the second heat source, and the cooling fan; and
based on the operating time of the air-frying mode reaching the preset time, opening the guide duct.

18. The method of claim 17, wherein the stopping of the driving of the first heat source, the second heat source, and the cooling fan, based on the operating time of the air-frying mode reaching the preset time, comprises:
in response to the operating time of the air-frying mode reaching the preset time, stopping the driving of the first heat source and the second heat source; and
in response to the operating time of the air-frying mode reaching the preset time, stopping the driving of the cooling fan after maintaining the driving of the cooling fan for a predetermined period of time.

19. The method of claim 17,
wherein the stopping of the driving of the first heat source, the second heat source, and the cooling fan, based on the operating time of the air-frying mode reaching the preset time, comprises:
in response to the operating time of the air-frying mode reaching the preset time, stopping the driving of the first heat source and the second heat source, and
wherein the opening of the guide duct, based on the operating time of the air-frying mode reaching the preset time, comprises:
in response to the operating time of the air-frying mode reaching the preset time, opening the guide duct after maintaining the closure of the guide duct for a predetermined period of time.

20. The method of claim 15, further comprising:
based on an oven mode, among the plurality of modes, being started, closing the guide duct; or
based on a range mode or a grill mode, among the plurality of modes, being started, maintaining an open state of the guide duct.
